(19) United States
(12) Patent Application Publication
(10) Pub. No.: US 2026/0299485 A1
(43) Pub. Date: Oct. 1, 2026

(54) IMAGE FORMING APPARATUS

(71) Applicant: CANON KABUSHIKI KAISHA, Tokyo (JP)

(72) Inventors: TAKAYUKI NAMIKI, Kanagawa (JP); SHUHEI TOKIWA, Tokyo (JP); YUTA ISOBE, Kanagawa (JP); TAKAHIRO KAWAMOTO, Kanagawa (JP)

(21) Appl. No.: 19/572,611

(22) Filed: Mar. 19, 2026

(30) Foreign Application Priority Data
Mar. 25, 2025 (JP) 2025-050555
Feb. 2, 2026 (JP) 2026-015579

(51) Int. Cl. G03G 15/00; G03G 15/08

(52) U.S. Cl. CPC G03G 15/556; G03G 15/0856; G03G 15/0863; G03G 15/0865; G03G 15/0894; G03G 15/5016

(57) ABSTRACT

An image forming apparatus is configured to detachably receive a cartridge including a developer container and a memory storing remanufacture processing information. The apparatus includes a measuring unit for measuring developer-related values, and a controller comprising a direct detection unit for detecting a first developer amount based on measured values, an estimation unit for estimating a second developer amount independently of the measuring unit, and a determination unit for evaluating cartridge end-of-life. When the remanufacture processing information indicates that the cartridge has been remanufactured, the controller directs the determination unit to determine the cartridge end-of-life based on the second (estimated) information without using the first information. Conversely, when the information indicates the cartridge is not remanufactured, the determination is performed based on the first (detected) information.

### BACKGROUND

### Field of the Technology

The present disclosure relates to an image forming apparatus.

### Description of the Related Art

An image forming apparatus operating by an electrophotographic system forms an image using a developer (also referred to as toner). Typically, the developer is supplied from a cartridge that is removably mounted to the image forming apparatus. When the developer in the cartridge is depleted, a user removes the original cartridge and mounts a new cartridge to the image forming apparatus.

In recent years, due to increasing environmental awareness, efforts have been made to design cartridges in advance such that used cartridges can be remanufactured and reused in image forming apparatuses instead of being discarded. A remanufacturer performs operations such as disassembly, cleaning, replacement of deteriorated parts, refilling of developer, and reassembly, for collected used cartridges.

Japanese Patent Laid-Open No. H9-114334 discloses a technique for counting the number of times a cartridge has been reused and preventing the use of a cartridge for which the number of times of reuse exceeds an operation limit. Japanese Patent Laid-Open No. 2005-331539 discloses a technique in which a memory holding data indicating a remaining lifespan for each part is mounted on a cartridge, and when a part is replaced in remanufacturing, the data in the memory for the replaced part is updated. The memory of the cartridge in Japanese Patent Laid-Open No. 2005-331539 holds information on the remaining amount of developer, and the remaining amount information is reset when the developer is refilled.

According to the technique of Japanese Patent Laid-Open No. 2005-331539, even when a remanufactured cartridge is reused, information on the remaining amount of developer can be updated at any time and provided to the user. However, the configuration of the remanufactured cartridge is not necessarily the same as the configuration at the time the cartridge was new. If a part of the cartridge is replaced, there is a possibility that a mechanism for remaining amount detection that was operating effectively before the replacement may not operate properly after the remanufacture, and in that case, the accuracy of the remaining amount information is not guaranteed.

### SUMMARY

In view of the above-mentioned points, the present disclosure is intended to improve detection of the remaining amount of developer in a remanufactured cartridge. This contributes to the realization of a sustainable society such as a decarbonized/circular economy society.

One aspect of the present disclosure provides an image forming apparatus to which a cartridge is detachably mountable, the cartridge having a container for containing developer and a memory for storing remanufacture processing information indicating whether the cartridge has undergone a remanufacture, the image forming apparatus being for forming an image based on input image data on a sheet using the developer, the image forming apparatus comprising: a measuring unit configured to measure a first value when an amount of the developer contained in the container is a first amount, and measure a second value different from the first value when the amount of the developer is a second amount smaller than the first amount; a direct detection unit configured to detect first information regarding the amount of the developer of the cartridge based on the value measured by the measuring unit; an estimation unit configured to estimate second information regarding the amount of the developer of the cartridge without using the value measured by the measuring unit; a determination unit configured to make a determination on an end-of-life of the cartridge based on the first information or the second information; and a control unit configured to control the measuring unit, the direct detection unit, the estimation unit, and the determination unit, and acquire the remanufacture processing information stored in the memory, wherein the control unit controls the determination unit to: make the determination on the end-of-life of the cartridge based on the second information and not based on the first information when the remanufacture processing information indicates that remanufacture has been performed, and make the determination on the end-of-life of the cartridge based on the first information when the remanufacture processing information indicates that remanufacture has not been performed.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic cross-sectional view showing an example of an overall configuration of an image forming apparatus according to one embodiment.

FIG. 2 is a schematic cross-sectional view showing another example of an overall configuration of an image forming apparatus according to one embodiment.

FIG. 3 is an explanatory diagram for explaining a remanufacture of a cartridge.

FIG. 4 is a perspective view of a developing unit.

FIG. 5 is a schematic view of a light transmissive part of the developing unit seen from the inside of a toner storage part.

FIG. 6 is a block diagram showing an example of a configuration of a controller and related units of an image forming apparatus according to one embodiment.

FIG. 7A is a first explanatory diagram of an example of a configuration of a cartridge memory.

FIG. 7B is a second explanatory diagram of an example of a configuration of a cartridge memory.

FIG. 8 is a flowchart showing an example of a flow of remaining amount detection processing by a first detection method.

FIG. 9 is a flowchart showing an example of a flow of remaining amount detection processing by a second detection method.

FIG. 10A is a flowchart showing a first example of a flow of remaining amount information update processing according to a first embodiment.

FIG. 10B is a flowchart showing a second example of a flow of remaining amount information update processing according to the first embodiment.

FIG. 11A is a first explanatory diagram of an example of a configuration of a cartridge memory in a modification of the first embodiment.

FIG. 11B is a second explanatory diagram of an example of a configuration of a cartridge memory in a modification of the first embodiment.

FIG. 11C is a third explanatory diagram of an example of a configuration of a cartridge memory in a modification of the first embodiment.

FIG. 12 is a flowchart showing an example of a flow of remaining amount information update processing according to a modification of the first embodiment.

FIG. 13 is a flowchart showing an example of a flow of remaining amount information update processing according to a second embodiment.

FIG. 14A is a schematic cross-sectional view showing an example of a configuration of a large-capacity cartridge.

FIG. 14B is a schematic cross-sectional view showing an example of a configuration of a medium-capacity cartridge.

FIG. 14C is a schematic cross-sectional view showing an example of a configuration of a small-capacity cartridge.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Example of Overall Configuration of Image Forming Apparatus

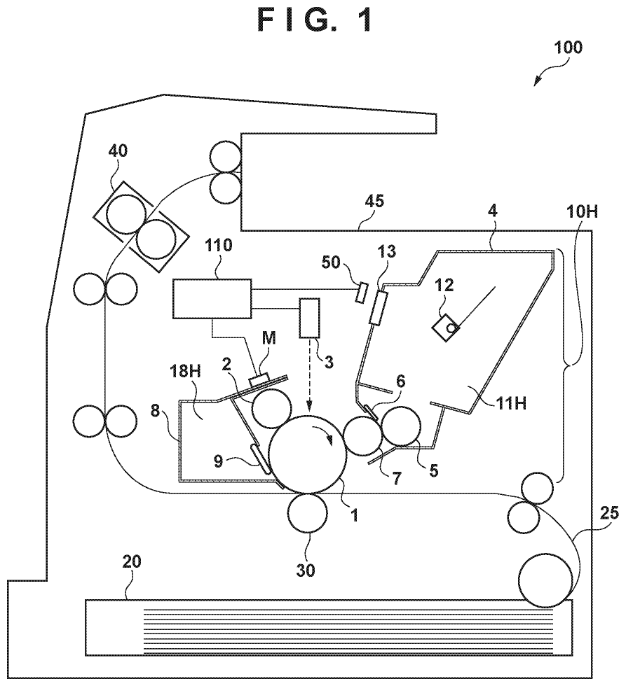

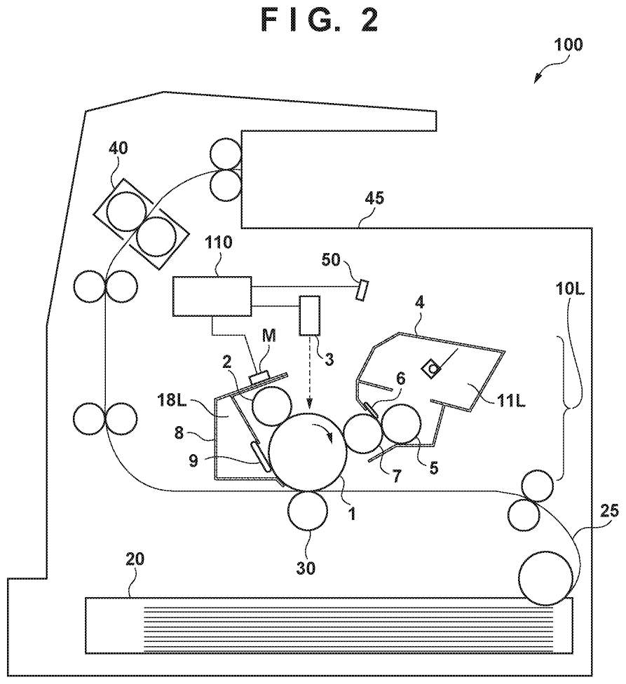

First, an overall configuration of an image forming apparatus 100 according to one embodiment will be described using FIG. 1 and FIG. 2. The image forming apparatus 100 is an apparatus that forms an image on a sheet using toner supplied from a cartridge that is removably (detachably) mounted. In this section, an example in which the image forming apparatus 100 is a monochrome printer is mainly described. However, the technique according to the present disclosure is also applicable to a color printer. Further, the technique according to the present disclosure is also applicable to other types of image forming apparatuses such as a copier, a multi-function peripheral, and a facsimile receiver.

FIG. 1 shows an example in which a cartridge (also referred to as a large-capacity cartridge) 10H capable of accommodating a relatively large amount of toner is mounted in the image forming apparatus 100. FIG. 2 shows an example in which a cartridge (also referred to as a small-capacity cartridge) 10L capable of accommodating a relatively small amount of toner is mounted in the image forming apparatus 100.

Referring to FIG. 1, the image forming apparatus 100 includes, in addition to the cartridge 10H, an exposure unit 3, a paper feed tray 20, a conveyance path 25, a transfer roller 30, a fixing unit 40, a discharge tray 45, a measurement unit 50, and a controller 110. The cartridge 10H includes a photosensitive member 1, a charging roller 2, a developing unit 4, and a cleaning unit 8. The developing unit 4 has a supply roller 5, a developing blade 6, a developing roller 7, a toner storage part 11H, an agitator 12, and a light transmissive part 13. The cleaning unit 8 has a cleaning blade 9 and a waste toner container 18H. In the present embodiment, the cartridge 10H is a so-called process cartridge and functions as image forming unit configured to form an image based on input image data on a sheet. The image forming apparatus 100 further has a power supply (not shown).

The photosensitive member 1 is a cylindrical image bearing member. The photosensitive member 1 is driven by a motor (not shown) and rotates clockwise in the drawing at a predetermined process speed. A predetermined charging voltage is applied to the charging roller 2 from the power supply and the charging roller 2 charges the surface of the photosensitive member 1 to a uniform potential. The exposure unit 3 forms an electrostatic latent image on the surface of the photosensitive member 1 by exposing the charged surface of the photosensitive member 1 with light modulated according to input image data. The exposure unit 3 may be a laser-type device that scans the surface of the photosensitive member 1 with laser light from a semiconductor laser, or may be a solid-state exposure-type device that forms an image of light from a plurality of light emitting elements (LEDs) arranged along an axial direction of the photosensitive member 1 on the surface of the photosensitive member 1. The toner storage part 11H accommodates toner internally. The agitator 12 has a plate-like member that rotates around a rotation axis and agitates the toner in the toner storage part 11H. The supply roller 5 and the developing roller 7 are rotatably supported by the developing unit 4. The supply roller 5 applies the toner supplied from the toner storage part 11H to the developing roller 7. The developing blade 6 is an elastic member and regulates and uniformizes the thickness of the toner applied to the surface of the developing roller 7 to form a layer. A predetermined developing voltage is applied to the developing roller 7 from the power supply, and the developing roller 7 develops the electrostatic latent image on the surface of the photosensitive member 1 with toner, and forms a toner image (developer image). The developing voltage promotes the transfer of toner from the developing roller 7 to the surface of the photosensitive member 1.

As an example, the toner may be a non-magnetic one-component developer. In this case, the developing roller 7 carries toner mainly by intermolecular force or electrostatic force (image force). The one-component developer may include not only toner particles but also additives (for example, wax or silica fine particles) for adjusting the fluidity and charging property of the toner. As another example, the toner may be a magnetic one-component developer containing a magnetic component, or may be a two-component developer containing non-magnetic toner particles and a magnetic carrier. In this case, the developing roller 7 may be a cylindrical developing sleeve having a magnet inside, and can carry toner by its magnetism.

The paper feed tray 20 accommodates a bundle of sheets. At the time of execution of a print job, sheets are fed one by one from the paper feed tray 20 to the conveyance path 25. The sheet is conveyed by a plurality of conveyance rollers and reaches a transfer nip between the photosensitive member 1 and the transfer roller 30. A predetermined transfer voltage is applied to the transfer roller 30 from the power supply and the transfer roller 30 transfers the toner image on the surface of the photosensitive member 1 onto the sheet. The sheet onto which the toner image has been transferred is further conveyed downstream along the conveyance path 25 and reaches the fixing unit 40. The fixing unit 40 heats the toner image with heat from a heat source (for example, a ceramic heater) while sandwiching and conveying the sheet, and also presses the sheet with a pressure roller. Thereby, the toner of the toner image melts, and the toner image is fixed to the sheet. The fixing unit 40 may have a sensor (for example, a thermistor) for measuring the temperature of a fixing film in contact with the sheet, and the fixing temperature can be maintained near a target temperature based on the sensor output. The sheet that has passed through the fixing unit 40 is discharged to the discharge tray 45 by a discharge roller.

The cleaning blade 9 is a plate-like member fixedly disposed in the cleaning unit 8. The cleaning blade 9 removes toner remaining on the surface of the photosensitive member 1 after the transfer of the toner image onto the sheet. The waste toner container 18H accommodates the toner removed by the cleaning blade 9.

Referring to FIG. 2, a cartridge 10L is mounted in the image forming apparatus 100 instead of the cartridge 10H. The developing unit 4 of the cartridge 10L has a toner storage part 11L having a smaller capacity than the toner storage part 11H of the cartridge 10H. Further, the cleaning unit 8 of the cartridge 10L has a waste toner container 18L having a smaller capacity than the waste toner container 18H of the cartridge 10H.

For example, the large-capacity cartridge 10H has a toner capacity that enables printing on 12,000 sheets of A4 size at a print ratio of 5%. Also, as shown in FIG. 1, the developing unit 4 of the large-capacity cartridge 10H has a light transmissive part 13 disposed on a wall surface of the toner storage part 11H. Meanwhile, the small-capacity cartridge 10L has a toner capacity that enables printing on 3,000 sheets of A4 size at a print ratio of 5%. Also, the developing unit 4 of the small-capacity cartridge 10L does not have the light transmissive part 13. In the following description, when it is not necessary to distinguish the cartridges 10H and 10L from each other, they are collectively referred to as the cartridge 10. The same applies to the toner storage part 11 (11H and 11L) and the waste toner container 18 (18H and 18L).

### 2. Cartridge Remanufacture Processing

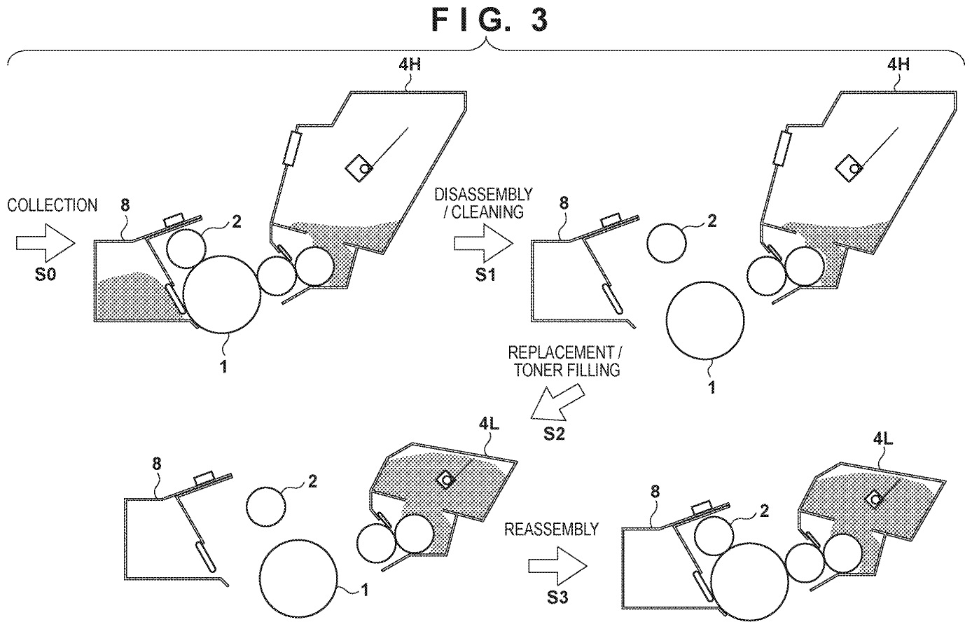

The image forming apparatus 100 can be mounted with not only a new cartridge 10 but also a remanufactured cartridge 10. The remanufacture processing may be performed by a manufacturer that manufactures new cartridges 10, or may be performed by another operator authorized by the manufacturer. In either case, here, the operator who performs the remanufacture processing is called a remanufacturer. FIG. 3 is an explanatory diagram for explaining the remanufacture of the cartridge 10.

Referring to FIG. 3, a used process cartridge including a photosensitive member 1, a charging roller 2, a developing unit 4H, and a cleaning unit 8 is shown at the upper left. A process step S0 is a step in which a collector collects a used process cartridge from a user. The collector delivers the collected process cartridge to a remanufacturer. In a process step S1, the remanufacturer disassembles the process cartridge into a plurality of parts and cleans each part. Next, in a process S2, the remanufacturer inspects each part and replaces parts that have failed, deteriorated, or for which the remaining lifespan has become short, with other parts. At this time, the new parts are not necessarily of the same specifications as the original parts. In the example of FIG. 3, a large-capacity developing unit 4H is replaced with a small-capacity developing unit 4L. The used developing unit 4H may be further disassembled into finer parts and recycled. The remanufacturer fills the developing unit 4L after the replacement with toner. Next, in a process step S3, the remanufacturer assembles the plurality of parts to remanufacture the process cartridge.

Thus, the image forming apparatus 100 can be mounted with one of a plurality of types of cartridges 10 having different specifications. A cartridge memory M disposed in each cartridge 10 stores information related to the specifications of the cartridge 10. The cartridge memory M may be, for example, an integrated circuit (IC) chip mounted with a semiconductor memory. In the examples of FIG. 1 to FIG. 3, the cartridge memory M is disposed in a housing of the cleaning unit 8. However, the cartridge memory M may be disposed at another position of the cartridge 10. Information written in the cartridge memory M will be described in detail later.

### 3. Measurement of Physical Attribute

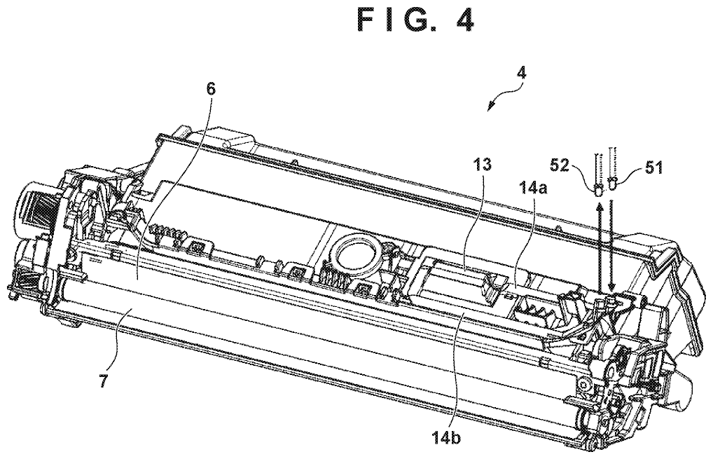

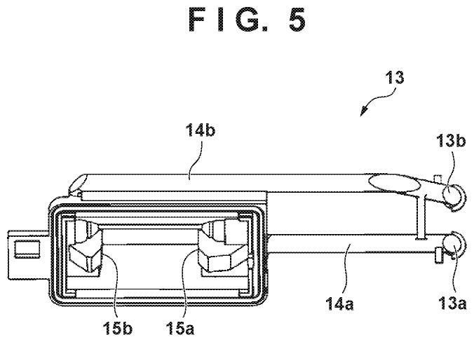

The measurement unit 50 of the image forming apparatus 100 measures a physical attribute depending on a remaining amount of toner in the cartridge 10. In the present embodiment, the measurement unit 50 measures a light shielding rate of toner in the toner storage part 11 of the cartridge 10 as a physical attribute depending on the remaining amount of toner. An example of a configuration for measuring the light shielding rate of toner will be described using FIG. 4 and FIG. 5.

FIG. 4 is a perspective view of the developing unit 4. FIG. 5 is a schematic view of the light transmissive part 13 of the developing unit 4 seen from the inside of the toner storage part 11H. The light transmissive part 13 has an incident hole 13a, an exit hole 13b, a first light guide path 14a, a second light guide path 14b, an incident window 15a, and an exit window 15b. Further, the measurement unit 50 has a light emitting element 51 and a light receiving element 52, and a signal processing circuit (not shown).

The light emitting element 51 of the measurement unit 50 is inserted into the incident hole 13a. The light receiving element 52 of the measurement unit 50 is inserted into the exit hole 13b. The first light guide path 14a guides light emitted from the light emitting element 51 inserted into the incident hole 13a to the incident window 15a. The light that has passed through the first light guide path 14a is radiated into the inside of the toner storage part 11H through the incident window 15a. A part of the radiated light is shielded by the toner remaining inside the toner storage part 11H, and another part enters the second light guide path 14b through the exit window 15b. The second light guide path 14b guides the light that has entered the exit window 15b to the exit hole 13b. The light receiving element 52 detects the light that has reached the exit hole 13b and outputs a detection signal indicating the intensity of the detected light to the measurement unit 50.

The measurement unit 50 receives the light emitted from the light emitting element 51 by the light receiving element 52 through the light transmissive part 13, converts the received light signal into a voltage signal, and outputs the voltage signal. The fact that the voltage value changes in accordance with the amount of received light of the light signal is used as an index of the toner remaining amount.

An example of a method for detecting information on the toner remaining amount based on the value measured by the measurement unit 50 will be described. The detection method of information on the toner remaining amount described here is direct detection, which will be described later. In the present embodiment, when toner enters the light transmissive part 13 along with the operation of the agitator 12, the light received by the light receiving element 52 is shielded by the toner. The voltage value associated with the light signal received by the light receiving element 52 is different when it is shielded by toner and when it is not. When the amount of toner in the storage part 11H is large, the light shielding time of the light received by the light receiving element becomes long along with the operation of the agitator 12, and when the toner amount is small, the light shielding time becomes short. In this way, a system that detects information on the toner remaining amount by measuring a voltage value associated with a light signal received by the light receiving element 52 is also called an optical transmission type system.

The measurement unit 50 detects whether or not a voltage value associated with a light signal received by the light receiving element 52 is a value corresponding to when light is shielded. Then, the measurement unit 50 detects a time (light shielding time) during which the light signal per unit operation time of the agitator 12 is the voltage value at the time of light shielding. Since the light shielding time changes in accordance with the amount of toner in the storage part 11H, the light shielding time can be used as an index of the toner remaining amount. For example, by storing information showing a relationship between the light shielding time and the amount of toner in the storage part 11H as a table in the image forming apparatus, the measurement unit 50 can detect information on the toner remaining amount. The light shielding time when the toner amount is large corresponds to a first value when the amount of developer in the present disclosure is a first amount, and the light shielding time when the toner amount is small corresponds to a second value when the amount of developer in the present disclosure is a second amount that is smaller than the first amount. The first amount and the second amount only need to correspond to the amount of developer, and the second amount may be larger than the first amount or the second amount may be smaller than the first amount.

The physical attribute depending on the toner remaining amount measured by the measurement unit 50 is not limited to the light shielding time of the light receiving element 52 described above. For example, the measurement unit 50 may measure a voltage value or a current value that changes in accordance with an electrostatic capacity between a pair of electrodes disposed in the toner storage part 11 of the cartridge 10 as a physical attribute depending on the toner remaining amount. Further, the measurement unit 50 may measure a voltage value or a current value that changes in accordance with the weight of the cartridge 10 using a load sensor disposed at a position where the load of the cartridge 10 is applied as a physical attribute depending on the toner remaining amount.

Further, the measurement unit 50 may measure a voltage value or a current value that changes in accordance with a magnetic permeability of toner around a magnetic sensor using the magnetic sensor disposed in the toner storage part 11 as a physical attribute depending on the toner remaining amount. Further, a configuration may be adopted in which a float is provided on an upper surface of the toner in the toner storage part 11, and the position of the float follows the position of the upper surface of the toner in the toner storage part (toner level) as the toner is consumed. The measurement unit 50 may detect the position of the float as a voltage value or a current value by a sensor, and measure this voltage value or current value as a physical attribute depending on the toner remaining amount (toner level) in the toner storage part.

Further, as a method for detecting the toner remaining amount, the measurement unit 50 may detect a voltage value or a current value that changes in accordance with vibrating a piezoelectric element disposed in the toner storage part 11. When the piezoelectric element is provided in the toner storage part 11, toner adheres to the surface of the piezoelectric element. Then, the frequency of vibration of the piezoelectric element changes depending on the amount of toner adhering to the piezoelectric element. Utilizing this phenomenon, the measurement unit 50 may measure a voltage value or a current value due to back electromotive force generated from the piezoelectric element as a physical attribute depending on the toner remaining amount.

Further, the measurement unit 50 may measure a voltage value or a current value that changes in accordance with a load torque of the agitator 12 provided inside the toner storage part 11 as a physical attribute depending on the toner remaining amount. When the toner amount in the toner storage part 11 is large, the load torque of the agitator 12 becomes large.

As shown in FIG. 1, since the large-capacity cartridge 10H has the light transmissive part 13, it supports measurement of a physical attribute for detecting information on the toner remaining amount. On the other hand, as shown in FIG. 2, since the small-capacity cartridge 10L does not have the light transmissive part 13, it does not support measurement of a physical attribute for detecting information on the toner remaining amount. In the following description, measurement of a physical attribute for detecting information on the toner remaining amount is also referred to as physical remaining amount detection. The controller 110 determines such a difference in specifications of the cartridge 10 mounted in the image forming apparatus 100, and switches a method for detecting information on the toner remaining amount according to the determination result.

### 4. Example of Configuration of Controller

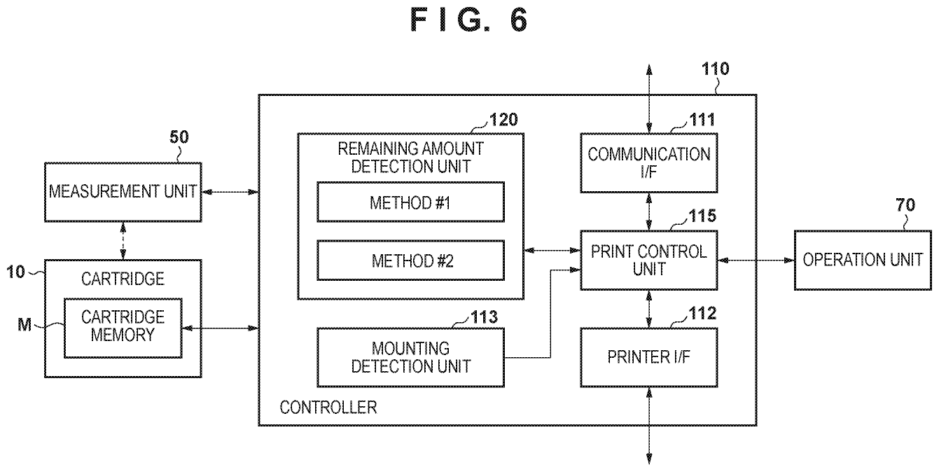

FIG. 6 is a block diagram showing an example of a configuration of a controller 110 and related units of the image forming apparatus 100. Referring to FIG. 6, the controller 110 includes a communication interface (I/F) 111, a printer I/F 112, a mounting detection unit 113, a printing control unit 115, and a remaining amount detection unit 120. The controller 110 is connected to the measurement unit 50, the operation unit 70, and the cartridge memory M of the cartridge 10.

The operation unit 70 provides a user interface to a user of the image forming apparatus 100. The operation unit 70 may include, for example, input devices such as a touch sensor, buttons, and switches, and output devices such as a display and a speaker. The communication I/F 111 is an interface for the image forming apparatus 100 to communicate with an external device (for example, a host computer or a user device). The printer I/F 112 is an interface for connecting the controller 110 to the various components described above that constitute an image forming unit. The mounting detection unit 113 detects whether or not the cartridge 10 is mounted in the image forming apparatus 100. The mounting of the cartridge 10 may be detected using a dedicated mounting sensor, or may be detected by communication with the cartridge memory M.

The printing control unit 115 and the remaining amount detection unit 120 may be functions implemented in software by a processor such as a central processing unit (CPU) executing a computer program loaded from a read-only memory (ROM) to a random access memory (RAM).

When execution of a print job is instructed, the printing control unit 115 controls the image forming unit to form an image on a sheet based on input image data that can be received via the communication I/F 111. When the print job is executed, toner accommodated in the cartridge 10 is consumed. The cartridge memory M stores remaining amount information indicating information on the remaining amount of toner in the cartridge 10. The remaining amount detection unit 120 detects information on the amount of toner in the cartridge 10 (for example, the remaining amount). When a print job is executed, the printing control unit 115 causes the remaining amount detection unit 120 to detect information on the latest toner remaining amount, and updates the remaining amount information in the cartridge memory M based on the detection result.

The printing control unit 115 also functions as a display control unit configured to cause a display unit to display information on the toner remaining amount. For example, the printing control unit 115 may cause the display unit to display remaining amount information read from the cartridge memory M. Further, when information on the latest toner remaining amount detected by the remaining amount detection unit 120 (detected toner remaining amount) is less than a predetermined remaining amount threshold, the printing control unit 115 may cause the display unit to display a warning message prompting the user to replace the cartridge 10. The display unit here may be a display of the operation unit 70 or a display of an external device that communicates with the image forming apparatus 100. The printing control unit 115, as the display control unit, performs display of information on the toner remaining amount, a remaining amount low display (the detected toner remaining amount is less than a predetermined remaining amount threshold), and a toner out display (the detected toner remaining amount corresponds to 0%) based on the detected toner remaining amount calculated by the remaining amount detection unit 120.

These displays are displayed based on the detected toner remaining amount which is updated by the remaining amount detection unit 120 in conjunction with a measurement result of information on the toner remaining amount based on a physical attribute by a sensor and detection of a toner consumption amount based on image data. The remaining amount detection unit 120 has a direct detection unit (not shown) and a remaining amount estimation unit (not shown). Detection of information on the toner remaining amount by measuring a physical attribute by a sensor is to detect by directly measuring the physical attribute related to the toner remaining amount by the sensor, and is called direct detection. Direct detection may also be called physical detection or sensor detection. Direct detection is to directly detect information on the toner remaining amount by measurement by a sensor, and can also be called hardware detection (hardware-based detection). In contrast, detection of a toner consumption amount based on image data such as a pixel count value by the remaining amount estimation unit is not measuring a physical attribute with a sensor, but is converting to a toner amount using the number of printed sheets on which an image has been formed, and detecting and estimating the toner consumption amount, and thus is also called indirect detection. Indirect detection by the remaining amount estimation unit is to detect a parameter and detect information on the toner remaining amount by an inference that the toner remaining amount will change if the parameter changes, and can also be called software-based detection.

The above-mentioned detection of the number of times light shielding is on/off or the light shielding time by the light receiving element 52, detection of electrostatic capacity between electrodes, detection of a toner surface position by the position of a float, detection of frequency by a piezoelectric element, and detection of load torque of the agitator 12 are examples of direct detection. In contrast, detection by a pixel count value by the remaining amount estimation unit, detection by the number of rotations of a photosensitive drum, and detection by the number of rotations of a developing roller are not for directly detecting information on the toner remaining amount, but are for estimating the toner remaining amount from information related to toner, and thus are examples of indirect detection. In the remaining amount detection unit 120, the direct detection unit detects information on the toner remaining amount acquired by direct detection, and the remaining amount estimation unit estimates information on the toner remaining amount by indirect detection.

As described above, the remaining amount detection unit 120 may detect the toner remaining amount itself by weight remaining amount detection or the like, or may detect the toner remaining amount by measuring a characteristic that changes in accordance with a change in the toner remaining amount or by calculating from a parameter related to the toner remaining amount. Detection by the light receiving element 52 or the like that is directly linked to the toner remaining amount is direct detection, and estimation of the toner remaining amount by calculation of a pixel count value based on the number of printed sheets is indirect detection.

A state in which the toner remaining amount in the cartridge is less than a predetermined remaining amount threshold (a state of being less than the threshold) is also called an end-of-life of the cartridge. The remaining amount threshold may be set to 0, and in that case, a toner out state of the cartridge is the end-of-life of the cartridge. Determination by the printing control unit 115 as to whether the toner remaining amount in the cartridge is less than a predetermined remaining amount threshold (less than the threshold) is also called a determination on the end-of-life of the cartridge.

### 5. Example of Configuration of Cartridge Memory

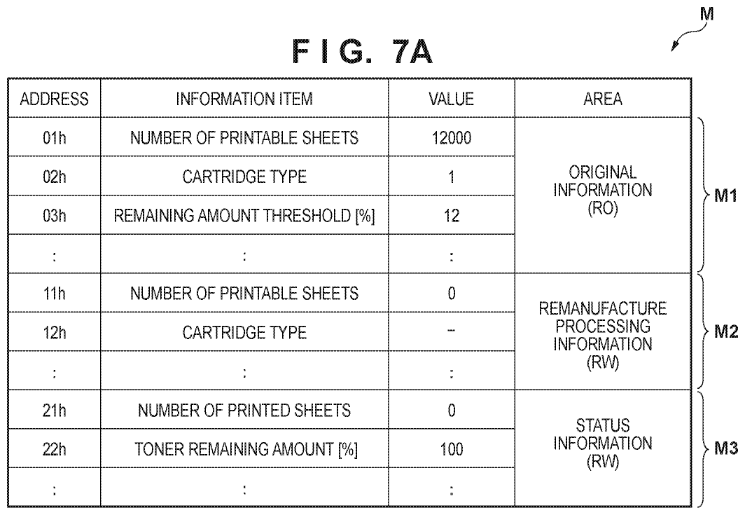

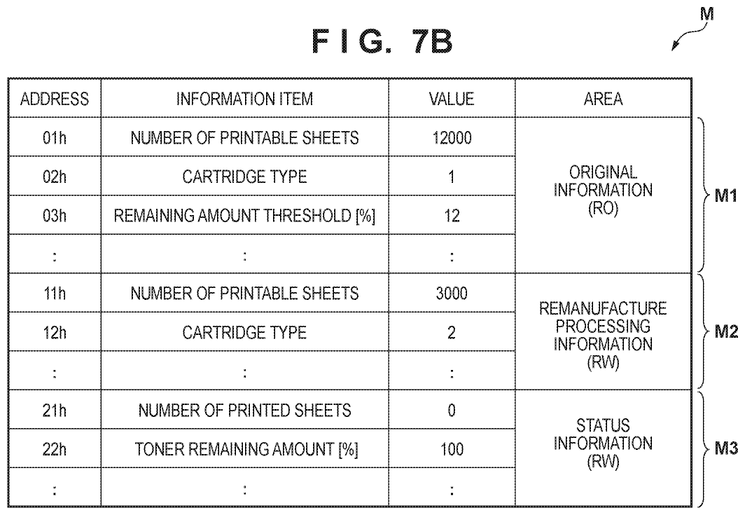

An example of a configuration of information stored in the cartridge memory M of the cartridge 10 will be described using FIG. 7A and FIG. 7B. FIG. 7A illustrates content of information written in the cartridge memory M at the time of manufacture of a new cartridge 10, and FIG. 7B illustrates content of information updated in the cartridge memory M at the time of remanufacture processing of the cartridge 10.

Referring to FIG. 7A, the cartridge memory M has an original information area M1, a remanufacture processing information area M2, and a status information area M3. The original information area M1 is a storage area in which information of a new cartridge 10 (hereinafter, referred to as original information) is written. The original information area M1 is read-only (RO). That is, after the original information is written once, reading of information from the original information area M1 is permitted, while writing of information to the original information area M1 is prohibited. The remanufacture processing information area M2 is a storage area in which information of the cartridge 10 after remanufacture processing (hereinafter, referred to as remanufacture processing information) is written. The remanufacture processing information area M2 is read-write (RW). That is, both reading of information from the remanufacture processing information area M2 and writing of information to the remanufacture processing information area M2 are permitted. The status information area M3 is a storage area in which status information regarding the use of toner in the cartridge 10 is written, regardless of whether remanufacture processing has been performed. The status information area M3 is read-write (RW), and both reading of information from the status information area M3 and writing of information to the status information area M3 are permitted. The remanufacture processing may be called reuse, and the remanufacture processing information may be called reuse information. When reuse (remanufacture processing) is performed, reuse information (remanufacture processing information) is stored in the remanufacture processing information area M2 as a history of the reuse (remanufacture processing).

More specifically, the original information includes information items of “number of printable sheets”, “cartridge type”, and “remaining amount threshold”. The “number of printable sheets” of the original information indicates a value calculated, for example, according to the ISO/IEC 19798 standard, based on the amount of toner filled in the toner storage part 11 at the time of manufacture of a new cartridge 10. The “cartridge type” of the original information is an identifier representing the type of a new cartridge 10. The “remaining amount threshold” indicates a threshold to be compared with information on the toner remaining amount for determination as to whether the warning message described above should be displayed.

The remanufacture processing information includes information items of “number of printable sheets” and “cartridge type”. The “number of printable sheets” of the remanufacture processing information indicates a value calculated, for example, according to the ISO/IEC 19798 standard, based on the amount of toner (re)filled in the toner storage part 11 at the time of remanufacture processing of the cartridge 10. As shown in FIG. 7A, at the time of manufacture of a new cartridge 10, the “number of printable sheets” of the remanufacture processing information indicates zero. In the example of FIG. 7B, the “number of printable sheets” of the remanufacture processing information has been updated to 3,000 sheets at the time of remanufacture processing. The “cartridge type” of the remanufacture processing information is an identifier representing the type of the cartridge 10 after remanufacture processing. For example, if the cartridge 10 part is replaced in remanufacture processing, the type of the cartridge 10 may be changed. Also, in the present embodiment, the information item of “cartridge type” indicates whether the cartridge is a large-capacity cartridge or a small-capacity cartridge. Therefore, the information of “cartridge type” can also be said to be information regarding a capacity of developer (toner) that can be accommodated in the cartridge. Note that the cartridge type may include information on three or more types of capacities, such as a medium-capacity cartridge, and may include information regarding the type of the cartridge other than that regarding capacity.

The status information includes information items of “number of printed sheets” and “toner remaining amount”. The “number of printed sheets” indicates the cumulative number of sheets on which image formation has been performed using the cartridge 10 being mounted. Each time a print job is executed, the “number of printed sheets” is updated. Also, at the time of remanufacture processing of the cartridge 10, the “number of printed sheets” is reset to zero. The “toner remaining amount” is information regarding remaining amount information indicating a detection result of information on the toner remaining amount by the remaining amount detection unit 120. At the time of manufacture and remanufacture processing of the cartridge 10, the “toner remaining amount” is initialized to 100 [%]. Further, each time a print job is executed, the “toner remaining amount” is updated based on the detection result by the remaining amount detection unit 120. Note that the status information may include a “cumulative pixel count value” in addition to the “number of printed sheets” and the “toner remaining amount”. The “cumulative pixel count value” indicates a cumulative number of pixels for which exposure was indicated as on during a period in which the cartridge 10 is mounted, and is used as an index for the remaining amount detection unit 120 to historically detect the toner consumption amount. The remaining amount detection unit 120 indirectly detects information on the toner remaining amount by the cumulative pixel count value and estimates the toner remaining amount. Each time a print job is executed, the “cumulative pixel count value” is updated, and it may be initialized to zero at the time of remanufacture processing.

### 6. Detection of Toner Remaining Amount Information, Estimation of Toner Remaining Amount

As described above, there is a possibility that the cartridge 10 part has been replaced at the time of remanufacture processing. Therefore, even if the image forming apparatus 100 has a measurement function for measuring a physical attribute depending on the toner remaining amount of the cartridge 10, there may be a case where the cartridge 10 does not support that measurement function. Therefore, in the present embodiment, the remaining amount detection unit 120 determines the specifications of the cartridge 10 mounted in the image forming apparatus 100, and switches a method for detecting information on the toner remaining amount between a first method and a second method based on the determined specifications.

### 6-1. First Method—Pixel Count System

The first method is a method that exclusively relies on a toner consumption amount detected from input image data. That is, when the first method is selected, the remaining amount detection unit 120 detects information regarding the toner remaining amount based on the toner consumption amount detected from the input image data without measuring a physical attribute for the cartridge 10, and makes a determination on the end-of-life of the cartridge from estimation of the toner remaining amount. Note that the index used for detection and estimation of the toner consumption amount is not limited to the pixel count value. For example, a toner usage amount in conjunction with other image forming operations such as the number of printed sheets, the number of rotations of a developing roller, the number of rotations of a photosensitive member, an image area ratio, an image density index, and detection of a toner application amount based on a rendering result of a page description language may be used as an index. The first method is a method that detects information on the toner remaining amount not by direct detection but by only indirect detection and performs estimation.

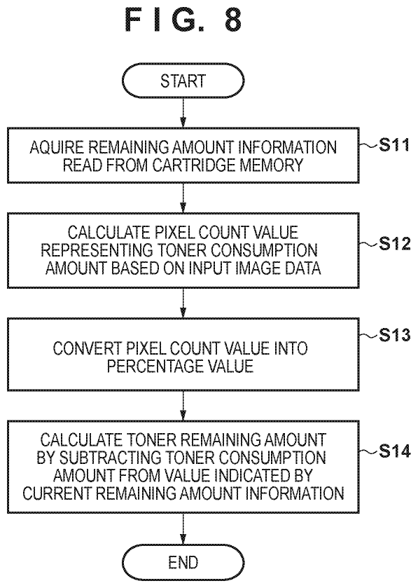

FIG. 8 is a flowchart showing an example of a flow of remaining amount detection processing by the first method. First, in step S11, the remaining amount detection unit 120 acquires remaining amount information (“toner remaining amount” in the status information area M3) read from the cartridge memory M. Next, in step S12, the remaining amount detection unit 120 calculates a pixel count value representing a toner consumption amount based on input image data of a print job.

The pixel count value here represents an integrated value of the number of pixels (also referred to as dots) exposed by the exposure unit 3. The remaining amount detection unit 120 can calculate the pixel count value, for example, by counting the number of pixels for which exposure is indicated as on in input image data that has been rasterized and binarized. Next, in step S13, the remaining amount detection unit 120 converts the pixel count value calculated in step S12 into a value representing the toner consumption amount as a percentage using a conversion formula or a conversion table defined in advance.

A “cumulative pixel count value” (not shown) of printed image data and a “total number of printable pixels” (not shown) are stored in a memory tag. The remaining amount detection unit 120 compares or calculates a ratio between the preset “total number of printable pixels” (not shown) and the “cumulative pixel count value” to calculate a value of the toner remaining amount to be notified to the user. In the present embodiment, the remaining amount detection unit 120 calculates a ratio between the “total number of printable pixels” corresponding to the “number of printable sheets” with the toner amount filled in the toner storage part 11 and the “cumulative pixel count value”, and detects the toner remaining amount “%”. The printing control unit 115 notifies the user by causing the operation unit 70 or the display of an external device to display the toner remaining amount “%”.

Further details will be described. In the present embodiment, the number of printable sheets on which an image can be formed (that can be printed) when a predetermined image pattern is repeatedly printed is referred to as the “number of printable sheets”. For example, if the number of printable sheets is 3,000, then 3,000 sheets of a predetermined image serving as a reference (A4 size paper, print ratio 4%) can be printed.

### <Regarding Total Number of Pixels>

The number of pixels exposed in a predetermined image serving as a reference (A4 size paper, print ratio 4%) is 1,349,379 pixels per sheet. Therefore, when 3,000 sheets is the number of printable sheets with the toner amount filled in the toner storage part, 1,349,379×3,000=4,048,137,000 is stored in the memory tag as the “total number of printable pixels” when full (toner remaining amount 100%).

### <Regarding Calculation of Toner Remaining Amount>

Next, calculation of the toner remaining amount to be notified to the user will be described. For example, a case where 1,000 sheets of a predetermined image serving as a reference have been printed will be described. The remaining amount detection unit 120 calculates the toner remaining amount by the following calculation formula and notifies the user of it as the toner remaining amount “%”.

$$( {}^{″} total number of printable {pixels}^{″} - {}^{″} cumulative pixel count {value}^{″} consumed by \text{printing)/} ( {}^{″} total number of printable {pixels}^{″} ) = ( 4 , 048 , 137 , 000 - 1 , 349 , 379 \times 1 , 000 ) / ( 4 , 048 , 137 , 000 ) \approx 66 {}^{″} {\%}^{″}$$

Here, the remaining amount detection unit 120 detects the toner remaining amount of 66%. The printing control unit 115 notifies the user by causing the operation unit 70 or the display of the external device to display the toner remaining amount “%”.

Similarly, when the number of printable sheets is 10,000, 1,349,379×10,000=13,493,790,000 is stored in the memory tag as the “total number of printable pixels” when full (toner remaining amount 100%), and the remaining amount detection unit 120 performs calculation of the toner remaining amount. When 1,000 sheets of a predetermined image serving as a reference have been printed, the remaining amount detection unit 120 calculates the toner remaining amount as follows.

$$( {}^{″} total number of printable {pixels}^{″} - {}^{″} cumulative pixel count {value}^{″} consumed by \text{printing)/} ( {}^{″} total number of printable {pixels}^{″} ) = ( 13 , 439 , 790 , 000 - 1 , 349 , 379 \times 1 , 000 ) / ( 13 , 493 , 790 , 000 ) = 90 {}^{″} {\%}^{″}$$

In the pixel count system, a difference will tend to arise in the actual toner consumption amount per pixel of an image depending on whether the image pattern is continuous pixels or isolated pixels, or depending on the environment in which the image forming apparatus is used or the status of use of the developing device. Therefore, the pixel count value may be multiplied by a coefficient in consideration of the image pattern, the use environment, and the status of use. The pixel count system does not directly detect the toner amount actually consumed. The pixel count system is for estimating and calculating the toner consumption amount in accordance with an average pixel count (A4 size paper, print ratio 4%) to be printed according to the number of printed sheets on which an image has been formed. Therefore, while the actual toner consumption amount depends on the data to be printed (print ratio), the toner consumption amount calculated by the pixel count system is calculated assuming that toner consumption has been performed at a print ratio of 4%, regardless of the data to be printed. Thus, the toner consumption amount calculated by the pixel count system and the actual toner consumption amount do not necessarily match.

Next, in step S14, the remaining amount detection unit 120 estimates and detects information on the latest toner remaining amount from a value indicated by current remaining amount information and the value derived in step S13. Since the first method uses a pixel count value, the first method is also called a pixel count system. Further, since the first method detects information on the toner remaining amount only by indirect detection, it is also called an indirect detection system.

### 6-2. Second Method—Combined System

The second method is a method that uses both a physical attribute measured for the cartridge 10 and a toner consumption amount detected from input image data. That is, when the second method is selected, the remaining amount detection unit 120 detects the toner remaining amount based on the physical attribute measured by the measurement unit 50 and the toner consumption amount detected from the input image data. In other words, the second method is a method that detects information on the toner remaining amount by using direct detection and indirect detection together. The remaining amount detection unit 120 detects information on the toner remaining amount based on both direct detection and indirect detection.

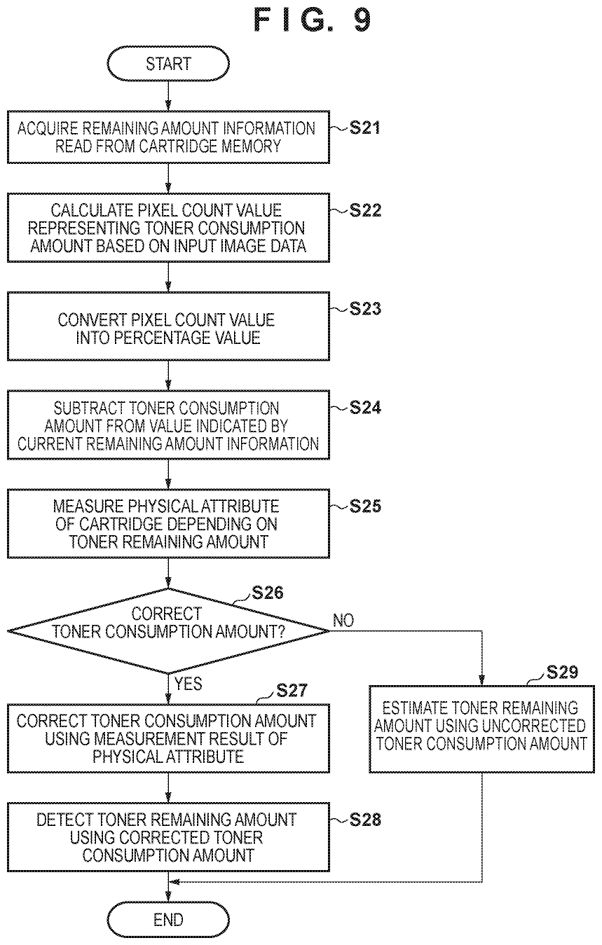

FIG. 9 is a flowchart showing an example of a flow of remaining amount detection processing by the second method. First, in step S21, the remaining amount detection unit 120 acquires remaining amount information read from the cartridge memory M. Next, in step S22, the remaining amount detection unit 120 calculates a pixel count value representing the toner consumption amount based on input image data of a print job. Next, in step S23, the remaining amount detection unit 120 converts the pixel count value calculated in step S22 into a value representing the toner consumption amount as a percentage using a conversion formula or a conversion table defined in advance. Next, in step S24, the remaining amount detection unit 120 estimates and detects information on a provisional toner remaining amount by subtracting the value of the toner consumption amount derived in step S23 from the value indicated by current remaining amount information.

Next, in step S25, the remaining amount detection unit 120 causes the measurement unit 50 to measure a physical attribute of the cartridge 10 that depends on the toner remaining amount. Next, in step S26, the remaining amount detection unit 120 determines whether or not the toner consumption amount derived from the pixel count value should be corrected. A reason for correcting the toner consumption amount is that the toner consumption amount acquired by indirect detection derived from the pixel count value may contain a difference due to an installation environment of the apparatus, printing conditions, individual differences of the apparatus, a degree of deterioration of parts, and the like. In contrast, direct detection based on a measurement result of the physical attribute of the cartridge 10 correlates well with the toner remaining amount, at least in a situation where at least a certain amount of toner remains. Therefore, the remaining amount detection unit 120 can determine that the toner consumption amount acquired by indirect detection should be corrected when the toner remaining amount acquired by indirect detection is not less than a certain reference value and a difference between the toner remaining amount acquired by indirect detection and the toner remaining amount acquired by direct detection exceeds a predetermined threshold.

Hereinafter, determination of necessity of correction or switching of a detection method in step S26 will be described. For example, the measurement unit 50 performs counting of whether light reception is on/off for a predetermined time (example: 1 [second]) at a predetermined sampling rate (example: 300 [Hz]) for a detection signal of the light receiving element 52. In the cartridge 10, when the agitator 12 rotates, light received by the light receiving element 52 is shielded by toner in the toner storage part 11H. When there is sufficient toner in the toner storage part 11H, along with rotation of the agitator 12, the light to the light receiving element 52 is shielded and an off state is entered. However, when the toner amount becomes small, even if the agitator 12 rotates, the light to the light receiving element 52 is not shielded, and a time during which an on state continues becomes long. For the detection signal of the light receiving element 52, the count of on/off state changes for light reception by the light receiving element 52 during the predetermined time at the predetermined sampling rate decreases. When a count value of light reception on/off state changes is less than or equal to a predetermined threshold (example: a count of 50), the remaining amount detection unit 120 can determine that light shielding by toner has become rare and reliability of detection of information on the toner remaining amount acquired by direct detection has decreased.

Such a determination result can be used as an example of a condition for determining necessity of correction or switching of a detection method in step S26. When the toner remaining amount is sufficient, the remaining amount detection unit 120 detects information on the toner remaining amount by direct detection, and in a low remaining amount range, the remaining amount detection unit 120 may switch to indirect detection such as the pixel count system. The remaining amount detection unit 120 can switch the method for detecting information on the toner remaining amount based on the fact that the toner remaining amount is less than (or equal to or less than) a remaining amount threshold as a trigger.

For example, when the number of on/off state changes for light reception by the light receiving element 52 is less than or equal to a predetermined threshold, the remaining amount detection unit 120 determines that reliability of a measurement result by direct detection of the physical attribute by the light receiving element 52 has decreased. Direct detection is not limited to detection of the toner remaining amount by the light receiving element 52, and it may be determined whether the toner remaining amount is less than or equal to a threshold by detection of the toner remaining amount by an electrostatic capacity between electrodes, a position of a float, a frequency by a piezoelectric element, a load torque of the agitator 12, or the like. In step S26, if the remaining amount detection unit 120 determines that the toner remaining amount acquired by direct detection is sufficient, it may advance processing to step S27, and if it determines that the toner remaining amount is not sufficient, it may advance processing to step S29. Further, if the remaining amount detection unit 120 determines that information on the toner remaining amount can be detected with high reliability by direct detection, it may advance processing to step S27, and if it determines that it cannot be detected with high reliability, it may advance processing to step S29.

In step S26, the remaining amount detection unit 120 may determine that the toner consumption amount should be corrected when the toner remaining amount acquired by indirect detection is not less than a certain reference value and a difference between the toner remaining amount acquired by indirect detection and the toner remaining amount acquired by direct detection exceeds a predetermined threshold.

If it is determined that the toner consumption amount should be corrected, in step S27, the remaining amount detection unit 120 corrects the toner consumption amount using the measurement result of the physical attribute by direct detection. For example, when the toner remaining amount corresponding to the measurement result of the physical attribute is larger than the provisional toner remaining amount, the remaining amount detection unit 120 may subtract an offset corresponding to the size of the difference from the toner consumption amount. Further, when the toner remaining amount corresponding to the measurement result of the physical attribute is smaller than the provisional toner remaining amount, the remaining amount detection unit 120 may add an offset corresponding to the size of the difference to the toner consumption amount. Further, the remaining amount detection unit 120 may detect the toner remaining amount based on information on the toner remaining amount acquired by direct detection. In this case, the provisional toner remaining amount acquired by indirect detection is not used. By doing so, the remaining amount detection unit 120 switches between direct detection and indirect detection depending on the toner remaining amount, and when the toner remaining amount is sufficient, detection of the toner remaining amount acquired by direct detection is performed.

Next, in step S28, the remaining amount detection unit 120 detects the latest toner remaining amount by subtracting a corrected value of the toner consumption amount from the value indicated by current remaining amount information. On the other hand, if it is determined that the toner consumption amount should not be corrected, in step S29, the remaining amount detection unit 120 makes the provisional toner remaining amount acquired by indirect detection derived in step S24 (the toner remaining amount derived using an uncorrected toner consumption amount) a detection result of information on the latest toner remaining amount. That is, in step S29, the toner remaining amount based on information on the toner remaining amount (toner consumption amount) by indirect detection is the detection result of information on the latest toner remaining amount.

Since the second method uses indirect detection by the pixel count value and direct detection by the physical attribute of the cartridge 10 together, the second method is also called a combined system. Note that the second method is not limited to the method described using FIG. 9. For example, within a range where the provisional toner remaining amount does not fall below a certain reference value, the toner remaining amount corresponding to the measurement result of the physical attribute of the cartridge 10 may be used as the detection result as it is without using the toner consumption amount derived from the pixel count value. In FIG. 9, information on the toner remaining amount may be detected by indirect detection in step S22 and step S23, and information on the toner remaining amount may be detected by direct detection in step S25.

### 7. Switching of Detection Method for Toner Remaining Amount

Switching of the method for detecting information on the toner remaining amount between the first method and the second method may be performed according to various conditions. In this section, several embodiments related to switching of the method for detecting information on the toner remaining amount will be described.

### 7-1. First Embodiment

In the first embodiment, the remaining amount detection unit 120 determines whether or not the cartridge 10 mounted in the image forming apparatus 100 supports measurement of the physical attribute by the measurement unit 50, that is, physical remaining amount detection. Then, when it is determined that the cartridge 10 does not support physical remaining amount detection, the remaining amount detection unit 120 estimates information on the toner remaining amount according to the first method, that is, the pixel count system. Further, when it is determined that the cartridge 10 supports physical remaining amount detection, the remaining amount detection unit 120 detects information on the toner remaining amount according to the second method, that is, the combined system.

### (1) Determination of Physical Remaining Amount Detection Based on Support Information

The cartridge memory M may store support information representing whether or not the cartridge 10 supports physical remaining amount detection. In this case, the remaining amount detection unit 120 can determine whether or not the cartridge 10 supports physical remaining amount detection based on the support information read from the cartridge memory M. The “cartridge type” shown in FIG. 7A and FIG. 7B is an example of the support information. For example, a cartridge identified by “cartridge type”=“1” supports physical remaining amount detection, while a cartridge identified by “cartridge type”=“2” does not support physical remaining amount detection. Alternatively, the “number of printable sheets” may be treated as the support information. For example, it is assumed that a large-capacity cartridge having a toner capacity exceeding a certain reference value always supports physical remaining amount detection. In this case, the remaining amount detection unit 120 can determine whether or not the remanufactured cartridge supports physical remaining amount detection by comparing the “number of printable sheets” of the remanufacture processing information with the reference value.

Determination based on such support information does not require operating the measurement unit 50. Therefore, it is possible to avoid a risk of a malfunction (for example, improper exposure of the photosensitive member 1 due to light emission from the measurement unit 50) caused by the measurement unit 50 operating despite a cartridge 10 that does not support physical remaining amount detection being mounted.

### (2) Determination of Physical Remaining Amount Detection Based on Attempt at Measurement

The remaining amount detection unit 120 may determine whether or not the cartridge 10 mounted in the image forming apparatus 100 supports physical remaining amount detection by causing the measurement unit 50 to attempt measurement of the physical attribute depending on the toner remaining amount in the cartridge 10. For example, a case is assumed where the physical attribute is a light shielding rate of the toner in the cartridge 10. In this case, the remaining amount detection unit 120 may determine that the cartridge 10 does not support physical remaining amount detection when light that has passed through the cartridge 10 is not detected despite instructing the measurement unit 50 to emit light.

Since determination based on such an attempt at measurement does not rely on the support information in the cartridge memory M, it functions effectively even if information in the cartridge memory M does not accurately reflect specifications of the cartridge 10 after remanufacture processing. Therefore, it is possible to avoid a situation where the combined system is not used for the cartridge 10 that supports physical remaining amount detection because information in the cartridge memory M is not accurate, and detection accuracy of information on the toner remaining amount decreases.

(3) Determination of Whether or not Remanufacture Processing has been Performed

The remaining amount detection unit 120 may determine whether or not the cartridge 10 has undergone remanufacture processing based on remanufacture processing information read from the cartridge memory M of the cartridge 10 mounted in the image forming apparatus 100. For example, when it is determined that the cartridge 10 mounted in the image forming apparatus 100 has undergone remanufacture processing, the remaining amount detection unit 120 performs the above-mentioned determination of whether or not the cartridge 10 supports physical remaining amount detection. On the other hand, when it is determined that the cartridge 10 has not undergone remanufacture processing (that is, it is new), the remaining amount detection unit 120 may select a default detection method for a new cartridge 10. The default detection method may be either the first method or the second method. In this way, by selecting the default detection method when the cartridge 10 has not undergone remanufacture processing, determination regarding support for physical remaining amount detection can be omitted, and efficiency of processing can be improved.

The “number of printable sheets” of the remanufacture processing information shown in FIG. 7A and FIG. 7B is an example of information representing whether or not the cartridge 10 has undergone remanufacture processing. For example, when the “number of printable sheets” of the remanufacture processing information indicates zero (or another initial value), it is determined that the cartridge 10 has not undergone remanufacture processing. On the other hand, when the “number of printable sheets” of the remanufacture processing information indicates a numerical value that is not the initial value, this means that the “number of printable sheets” has been updated at the time of remanufacture processing of the cartridge 10, and therefore it is determined that the cartridge 10 has undergone remanufacture processing. Alternatively, the “cartridge type” of the remanufacture processing information may be treated as the remanufacture processing information (for example, depending on whether or not it indicates an initial value).

### (4) Switching of Detection Method Based on Toner Filling Amount

Additionally, when it is determined that the cartridge 10 supports physical remaining amount detection, the remaining amount detection unit 120 may switch the method of detecting information on the toner remaining amount based on a filling amount of toner in the cartridge 10. Specifically, even when physical remaining amount detection is supported, the remaining amount detection unit 120 can detect information on the toner remaining amount according to the pixel count system instead of the combined system when the amount of toner filled in the cartridge 10 is less than a predetermined filling amount threshold. On the other hand, when physical remaining amount detection is supported, the remaining amount detection unit 120 can detect information on the toner remaining amount according to the combined system when the amount of toner filled in the cartridge 10 exceeds the filling amount threshold. For example, when the “number of printable sheets” of the remanufacture processing information is treated as filling amount information, the filling amount threshold may be equal to “5,000 sheets”. According to such a condition, it is possible to improve accuracy of a detection result by avoiding the combined system being used in a low remaining amount situation where the measurement result of the physical attribute of the cartridge 10 does not correlate well with the toner remaining amount. Note that, when physical remaining amount detection is supported, the remaining amount detection unit 120 may estimate and detect information on the toner remaining amount according to the pixel count system regardless of the filling amount threshold.

Note that the remanufacture processing information, the support information, and the filling amount information described up to this point may be indicated by separate information items, or two or more of them may be indicated by a common single information item.

### (5) Example of Process Flow

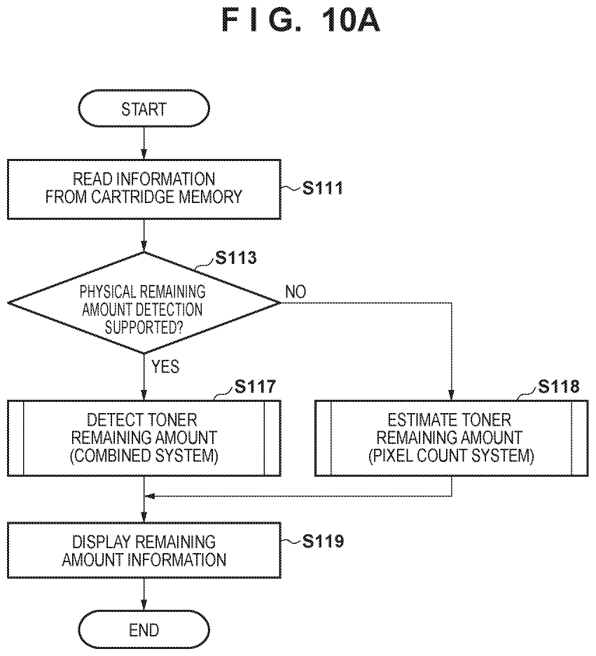

An example of a flow of processing that can be executed by the controller 110 in the first embodiment will be described using FIG. 10A and FIG. 10B.

FIG. 10A is a flowchart showing a first example of a flow of remaining amount information update processing according to the first embodiment. The remaining amount information update processing of FIG. 10A is performed by the controller 110 when the image forming apparatus 100 executes a print job.

First, in step S111, the printing control unit 115 reads original information, remanufacture processing information, and status information from the cartridge memory M of the cartridge 10 mounted in the image forming apparatus 100. The printing control unit 115 delivers the read information to the remaining amount detection unit 120.

Next, in step S113, the remaining amount detection unit 120 determines whether or not the cartridge 10 supports physical remaining amount detection. For example, the remaining amount detection unit 120 may determine whether or not the cartridge 10 supports physical remaining amount detection by referring to the support information read from the cartridge memory M. Alternatively, the remaining amount detection unit 120 may cause the measurement unit 50 to attempt measurement of the physical attribute depending on the toner remaining amount, and determine whether or not the cartridge 10 supports physical remaining amount detection based on a result of the attempt. If it is determined that the cartridge 10 supports physical remaining amount detection, the process advances to step S117. On the other hand, if it is determined that the cartridge 10 does not support physical remaining amount detection, the process advances to step S118.

In step S117, the remaining amount detection unit 120 selects the second method, that is, the combined system, and detects the toner remaining amount from the physical attribute measured by the measurement unit 50 and the toner consumption amount based on the input image data. The detailed flow of the remaining amount detection processing here is as described using FIG. 9.

In step S118, the remaining amount detection unit 120 selects the first method, that is, the pixel count system, and estimates the toner remaining amount based on the toner consumption amount estimated from the input image data. At this time, the remaining amount detection unit 120 may detect information on the toner remaining amount acquired by direct detection. The remaining amount detection unit 120 may estimate the toner remaining amount only by the toner consumption amount by the pixel count system and not use information on the toner remaining amount acquired by direct detection as a final toner remaining amount. The detailed flow of the remaining amount detection processing here is as described using FIG. 8.

Next, in step S119, the printing control unit 115 causes the operation unit 70 or the display of the external device to display the remaining amount information indicating the toner remaining amount detected by the remaining amount detection unit 120 in step S117 or step S118. Further, the printing control unit 115 updates the status information stored in the cartridge memory M so as to reflect the latest toner remaining amount. The printing control unit 115 updates the “toner remaining amount” in the status information, and can also update the “number of printed sheets” according to the number of sheets consumed in the print job.

In step S119, when information on the toner remaining amount detected by the remaining amount detection unit 120 is less than a predetermined remaining amount threshold, the printing control unit 115 may cause the display to display, together with the remaining amount information, a warning message prompting the user to replace the cartridge 10. Further, when power of the image forming apparatus 100 is turned on, the printing control unit 115 may read the “toner remaining amount” of the status information (and the “cumulative pixel count value” if necessary), and perform a remaining amount low display or a toner out display based on the detected toner remaining amount in advance. The display at the time of startup is based on a result of an update of the detected toner remaining amount up to a most recent time, and is not limited only to determination of the number of printed sheets.

Here, the printing control unit 115 has a function of making a determination on the end-of-life of the cartridge based on information on the toner remaining amount. Further, the printing control unit 115 has a function of acquiring and controlling information on the toner remaining amount detected by the remaining amount detection unit 120. The information on the toner remaining amount detected by the remaining amount detection unit 120 includes first information acquired by direct detection, second information acquired by indirect detection, and reuse information (remanufacture processing information). The printing control unit 115 is capable of executing a determination on the end-of-life of the cartridge 10 based on the information on the toner remaining amount acquired by direct detection and the information on the toner remaining amount acquired by indirect detection.

The determination on the end-of-life of the cartridge 10 in step S119 may be made as follows. The printing control unit 115 having a determination function makes the determination on the end-of-life of the cartridge 10 based on the first information acquired by direct detection or the second information acquired by indirect detection. The printing control unit 115 determines whether the first information acquired by direct detection or the second information acquired by indirect detection is less than the remaining amount threshold, and if it is less, the printing control unit 115 determines the end-of-life of the cartridge 10.

The printing control unit 115 as a control unit acquires the remanufacture processing information and determines whether the remanufacture processing information indicates that remanufacture has been performed. If the remanufacture processing information indicates that remanufacture has been performed, the printing control unit 115 determines whether the second information acquired by indirect detection is less than the remaining amount threshold, and if it is less, determines the end-of-life of the cartridge 10. At this time, the printing control unit 115 does not use the first information on the toner remaining amount acquired by direct detection for the determination on the end-of-life of the cartridge. The printing control unit 115 makes a determination on the end-of-life of the cartridge 10 based on the second information on the toner remaining amount acquired by indirect detection. Note that the printing control unit 115 may perform detection of information on the toner remaining amount by direct detection or acquisition of the information itself, while simply not using the information on the toner remaining amount acquired by direct detection for the determination on the end-of-life of the cartridge 10. Further, the form of indirect detection is not limited as long as it is not direct detection by measurement, as with a pixel count, information regarding the number of rotations of a photosensitive drum, and information regarding the number of rotations of a developing roller.

On the other hand, when the printing control unit 115 determines that the remanufacture processing information does not indicate that remanufacture has been performed, that is, when it determines that the cartridge is new, it determines whether first information acquired by direct detection is less than the remaining amount threshold, and if it is less, determines the end-of-life of the cartridge 10. Here, if it is determined as the end-of-life of the cartridge 10, the developer of the cartridge 10 is empty or in a state close to empty, and thus replacement of the cartridge is required. Note that when the cartridge 10 is new, the printing control unit 115 may make the determination on the end-of-life of the cartridge 10 by the second information on the toner remaining amount by indirect detection.

Then, the remaining amount information update processing of FIG. 10A ends. When the information on the toner remaining amount is less than the remaining amount threshold, the user who has seen the displayed warning message can remove the used cartridge 10 from the image forming apparatus 100 and mount a new cartridge 10 to the image forming apparatus 100. The used cartridge 10 can be collected by a collector and undergo remanufacture processing by a remanufacturer.

FIG. 10B is a flowchart showing a second example of a flow of remaining amount information update processing according to the first embodiment. The remaining amount information update processing of FIG. 10B is performed by the controller 110 when the image forming apparatus 100 executes a print job.

First, in step S111, the printing control unit 115 reads original information, remanufacture processing information, and status information from the cartridge memory M of the cartridge 10 mounted in the image forming apparatus 100. The printing control unit 115 delivers the read information to the remaining amount detection unit 120.

Next, in step S112, the remaining amount detection unit 120 determines whether or not the cartridge 10 has undergone remanufacture processing based on the remanufacture processing information read from the cartridge memory M. For example, the remaining amount detection unit 120 can determine whether or not the cartridge 10 has undergone remanufacture processing by referring to the “number of printable sheets” or the “cartridge type” of the remanufacture processing information. If it is determined that the cartridge 10 has undergone remanufacture processing, the process advances to step S113. On the other hand, if it is determined that the cartridge 10 has not undergone remanufacture processing, the process advances to step S115.

In step S113, the remaining amount detection unit 120 determines whether or not the cartridge 10 supports physical remaining amount detection. For example, the remaining amount detection unit 120 can determine whether or not the cartridge 10 supports physical remaining amount detection by referring to support information read from the cartridge memory M or by causing the measurement unit 50 to attempt measurement of a physical attribute. If it is determined that the cartridge 10 supports physical remaining amount detection, the process advances to step S114. On the other hand, if it is determined that the cartridge 10 does not support physical remaining amount detection, the process advances to step S118.

In step S114, the remaining amount detection unit 120 determines whether the toner filling amount of the cartridge 10 exceeds a predetermined filling amount threshold. For example, the “number of printable sheets” of the remanufacture processing information can be treated as filling amount information representing the toner filling amount in the cartridge 10 at the time of remanufacture processing. If the toner filling amount exceeds the filling amount threshold, the process advances to step S117. On the other hand, if the toner filling amount does not exceed the filling amount threshold, the process advances to step S118.

In step S115, the remaining amount information update processing branches depending on a remaining amount detection method to be selected for a new cartridge 10. If the combined system should be selected for a new cartridge 10, the process advances to step S117. On the other hand, if the pixel count system should be selected for a new cartridge 10, the process advances to step S118.

The subsequent step S117 to step S119 are the same processing steps as those described using FIG. 10A, and therefore repetition of description is omitted here. In step S117, the remaining amount detection unit 120 detects the toner remaining amount based on the first information on the toner remaining amount acquired by direct detection and the second information on the toner remaining amount acquired by indirect detection by the second method (combined system). Further, in step S118, the toner remaining amount is detected based on the second information on the toner remaining amount acquired by indirect detection, which is the first detection method. The remaining amount detection unit 120 determines a system for detecting the toner remaining amount depending on whether the toner filling amount exceeds the filling amount threshold. When the toner filling amount information exceeds the filling amount threshold, the printing control unit 115 detects the toner remaining amount by the second method (combined system) using direct detection and indirect detection. On the other hand, when the toner filling amount information is less than the filling amount threshold, the toner remaining amount is detected by the second information by the first detection method (indirect detection). Thereby, determination on the end-of-life of the cartridge can be made by the combined system or indirect detection depending on whether the toner filling amount exceeds the filling amount threshold.

### 7-2. Scenario Verification

In order to verify the effects of the above-described embodiment, three types of scenarios shown in the table below are considered.

TABLE 1

| | New | | After remanufacture | | | |
|---|---|---|---|---|---|---|
| | Number of | | Number of | Capacity | | |
| | printable | Cartridge | printable | Developing | Cleaning | Selected |
| Scenario | sheets | type | sheets | unit | unit | method |
| X1 | 3000 | Small | 12000 | Large | Small | Combined system |
| X2 | 3000 | Small | 3000 | Large | Small | Pixel count |
| X3 | 12000 | Large | 3000 | Small | Large | Pixel count |

In scenario X1, a small-capacity cartridge for which the number of printable sheets is 3,000 sheets is remanufactured after being used. By the remanufacture processing, the developing unit is replaced with a large-capacity unit that supports physical remaining amount detection, and the number of printable sheets after remanufacture increases to 12,000 sheets. In scenario X1, the remaining amount detection unit 120 can determine that the toner remaining amount can be detected with high accuracy for the remanufactured cartridge by the combined system by referring to the “number of printable sheets” or the “cartridge type” of the remanufacture processing information updated at the time of remanufacture processing. Alternatively, even if the information in the cartridge memory has not been accurately updated, the remaining amount detection unit 120 can determine that the information on the toner remaining amount can be detected with high accuracy by the combined system by causing the measurement unit 50 to attempt measurement of a physical attribute.

In scenario X2, a small-capacity cartridge for which the number of printable sheets is 3,000 sheets is remanufactured after being used. By the remanufacture processing, the developing unit is replaced with a large-capacity unit, but toner is filled only to about ¼ of the total capacity, and the number of printable sheets after remanufacture remains at 3,000 sheets. In scenario X2, if the detection method is selected only by an attempt at measurement of a physical attribute by the measurement unit 50, the combined system is selected, but the pixel count system is selected when the number of printable sheets is considered. In a situation where the information on the toner remaining amount is lower than the filling amount threshold (for example, 5,000 sheets), the measurement result of the physical attribute does not correlate well with the toner remaining amount, and thus in this scenario, the pixel count system may be selected.

In scenario X3, a large-capacity cartridge for which the number of printable sheets is 12,000 sheets is remanufactured after being used. By the remanufacture processing, the developing unit is replaced with a small-capacity unit that does not support physical remaining amount detection, and the number of printable sheets after the remanufacture decreases to 3,000 sheets. In scenario X3, the remaining amount detection unit 120 can determine that the pixel count system should be selected for the remanufactured cartridge by referring to the “number of printable sheets” or the “cartridge type” of the remanufacture processing information updated at the time of remanufacture processing. Alternatively, even if the information in the cartridge memory has not been accurately updated, the remaining amount detection unit 120 can appropriately determine that the pixel count system should be selected by causing the measurement unit 50 to attempt measurement of a physical attribute.

According to the first embodiment described above, when the configuration of the remanufactured cartridge has changed from the configuration at the time it was new, the remaining amount of toner in the remanufactured cartridge is detected by a detection method suitable for the configuration of the remanufactured cartridge. Thereby, since the accuracy of the remaining amount information is improved, timely arrangement of a replacement cartridge is supported, and a decrease in productivity caused by depletion of toner can be effectively avoided.

### 7-3. Modification

As a modification of the first embodiment, the support information in the cartridge memory M may be capable of indicating that it is unknown whether or not the cartridge 10 supports physical remaining amount detection. The remaining amount detection unit 120 may cause the measurement unit 50 to attempt measurement of a physical attribute depending on the toner remaining amount when the support information read from the cartridge memory M indicates that it is unknown whether or not the cartridge 10 supports physical remaining amount detection. On the other hand, when the support information read from the cartridge memory M explicitly indicates whether or not the cartridge 10 supports physical remaining amount detection, the remaining amount detection unit 120 does not have to cause the measurement unit 50 to attempt measurement of a physical attribute.

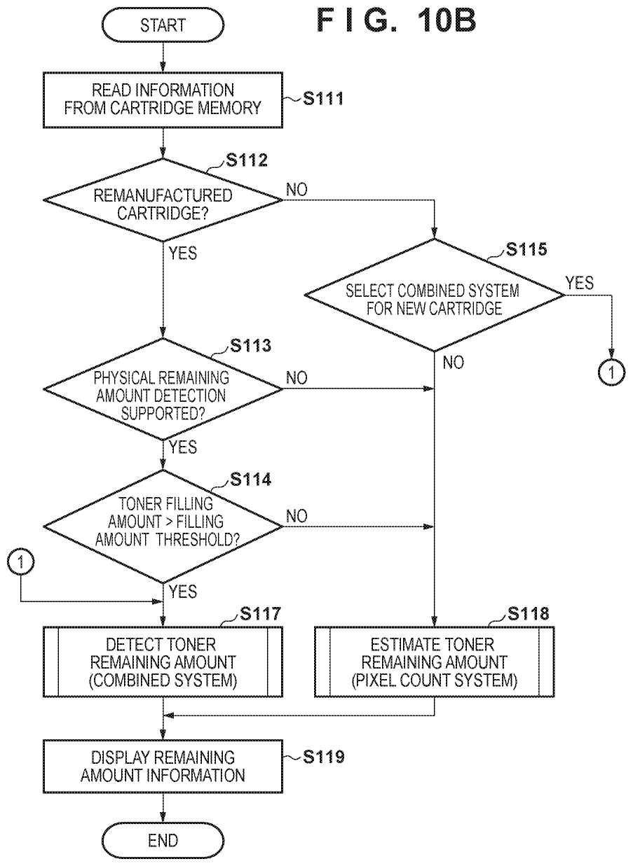

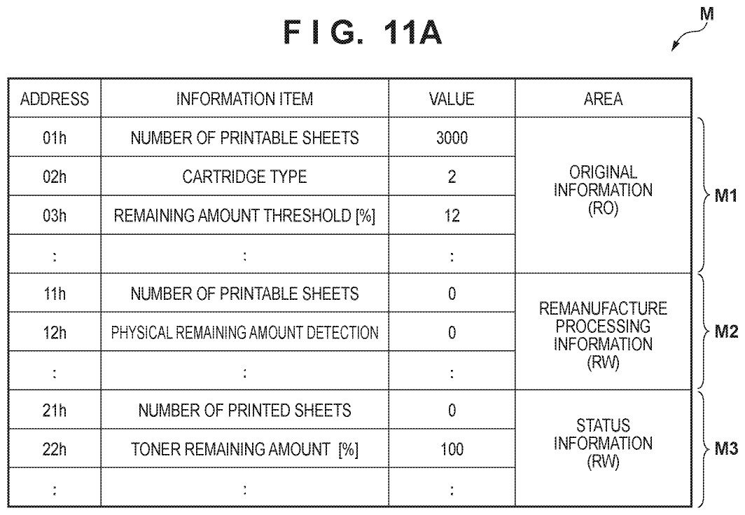

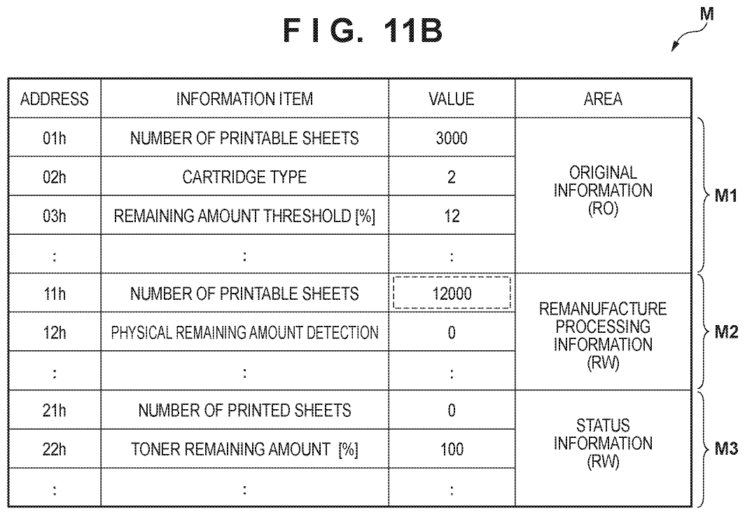

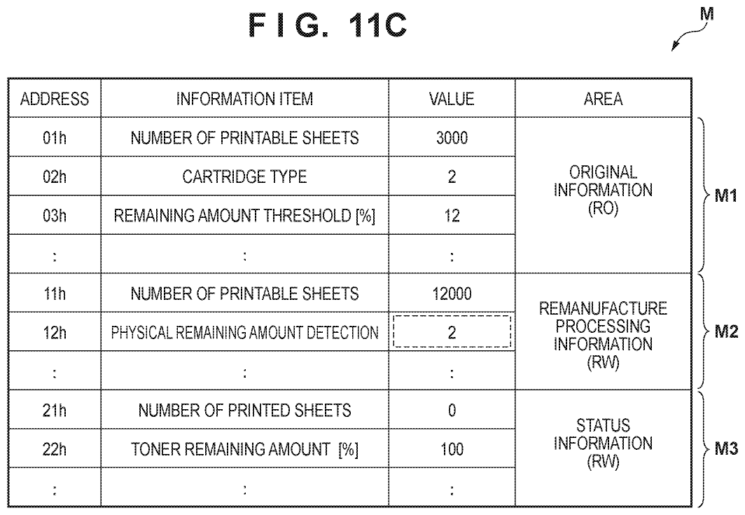

An example of a configuration of information stored in the cartridge memory M in this modification will be described using FIG. 11A to FIG. 11C. FIG. 11A illustrates the content of information written in the cartridge memory M at the time of manufacture of a new cartridge 10. Compared with FIG. 7A, in FIG. 11A, the information item at address “12 h” of the remanufacture processing information area M2 is changed from “cartridge type” to “physical remaining amount detection”. The “physical remaining amount detection” indicates, for example, one of the following three candidate values:
“0”: Support unknown
“1”: Physical remaining amount detection not supported
“2”: Physical remaining amount detection supported

That is, when the “physical remaining amount detection” of the remanufacture processing information indicates “0”, it is unknown whether or not the cartridge 10 supports physical remaining amount detection. When the “physical remaining amount detection” of the remanufacture processing information indicates “1”, the cartridge 10 does not support physical remaining amount detection. When the “physical remaining amount detection” of the remanufacture processing information indicates “2”, the cartridge 10 supports physical remaining amount detection.

In the example of FIG. 11A, since the cartridge 10 is new and has not undergone remanufacture processing, both the “number of printable sheets” and the “physical remaining amount detection” of the remanufacture processing information indicate zero. FIG. 11B illustrates the content of information written in the cartridge memory M at the time of remanufacture processing of the cartridge 10. In the example of FIG. 11B, since the “number of printable sheets” of the remanufacture processing information indicates a non-zero numerical value and the “physical remaining amount detection” indicates “0”, the remaining amount detection unit 120 knows that the cartridge 10 has undergone remanufacture processing and that it is unknown whether or not it supports physical remaining amount detection. Then, the remaining amount detection unit 120 causes the measurement unit 50 to attempt measurement of a physical attribute, and rewrites the value of “physical remaining amount detection” according to the result of the attempt. For example, when measurement of the physical attribute by the measurement unit 50 is successful and it is found that the cartridge 10 supports physical remaining amount detection, the value of “physical remaining amount detection” is rewritten to “2” as shown in FIG. 11C. After the value of “physical remaining amount detection” is rewritten in this way, the remaining amount detection unit 120 can determine the presence or absence of support for physical remaining amount detection simply by referring to the value of “physical remaining amount detection”, and a further attempt at measurement of a physical attribute is not required.

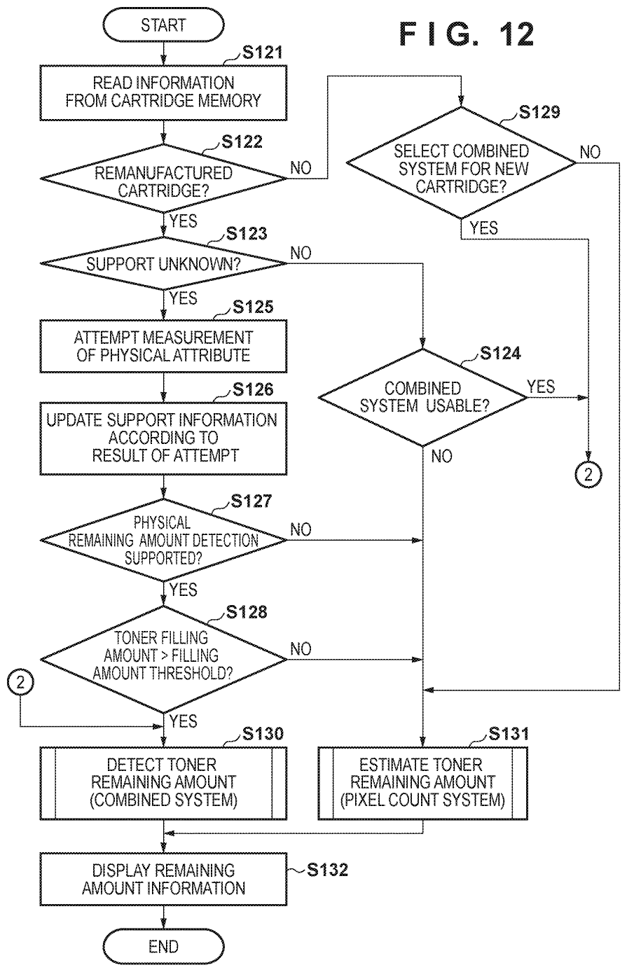

FIG. 12 is a flowchart showing an example of a flow of remaining amount information update processing according to this modification. The remaining amount information update processing of FIG. 12 is performed by the controller 110 when the image forming apparatus 100 executes a print job.

First, in step S121, the printing control unit 115 reads original information, remanufacture processing information, and status information from the cartridge memory M of the cartridge 10 mounted in the image forming apparatus 100. The printing control unit 115 delivers the read information to the remaining amount detection unit 120.

Next, in step S122, the remaining amount detection unit 120 determines whether or not the cartridge 10 has undergone remanufacture processing based on the remanufacture processing information read from the cartridge memory M. For example, the remaining amount detection unit 120 can determine whether or not the cartridge 10 has undergone remanufacture processing by referring to the “number of printable sheets” of the remanufacture processing information. If it is determined that the cartridge 10 has undergone remanufacture processing, the process advances to step S123. On the other hand, if it is determined that the cartridge 10 has not undergone remanufacture processing, the process advances to step S129.

In step S123, the remaining amount detection unit 120 refers to the support information included in the remanufacture processing information and determines whether or not it is unknown whether the cartridge 10 supports physical remaining amount detection. If the support is unknown, the process advances to step S125. On the other hand, if the presence or absence of support is explicitly shown by the support information, the process advances to step S124.

In step S124, the remaining amount information update processing branches depending on the presence or absence of support explicitly shown by the support information. If the support information indicates that the cartridge 10 supports physical remaining amount detection, the process advances to step S130 because the combined system is usable. On the other hand, if the support information indicates that the cartridge 10 does not support physical remaining amount detection, the process advances to step S131 because the combined system is not usable.

In step S125, the remaining amount detection unit 120 causes the measurement unit 50 to attempt measurement of a physical attribute. Next, in step S126, the remaining amount detection unit 120 updates the support information of the remanufacture processing information in the cartridge memory M according to the result of the attempt in step S125. If the attempt is successful, the cartridge 10 supports physical remaining amount detection. Therefore, the support information is updated to a value indicating that there is support. On the other hand, if the attempt at measurement of the physical attribute fails, the cartridge 10 does not support physical remaining amount detection. Therefore, the support information is updated to a value indicating that there is no support.

The subsequent processing branches in step S127 depending on the result of the attempt in step S125. If the attempt is successful and it is determined that the cartridge 10 supports physical remaining amount detection, the process advances to step S128. On the other hand, if the attempt fails and it is determined that the cartridge 10 does not support physical remaining amount detection, the process advances to step S131.

In step S128, the remaining amount detection unit 120 determines whether the toner filling amount of the cartridge 10 exceeds a predetermined filling amount threshold. For example, the “number of printable sheets” of the remanufacture processing information can be treated as filling amount information representing the toner filling amount. If the toner filling amount exceeds the filling amount threshold, the process advances to step S130. On the other hand, if the toner filling amount does not exceed the filling amount threshold, the process advances to step S131.

In step S129, the remaining amount information update processing branches depending on the remaining amount detection method to be selected for a new cartridge 10. If the combined system should be selected for a new cartridge 10, the process advances to step S130. On the other hand, if the pixel count system should be selected for a new cartridge 10, the process advances to step S131.

In step S130, the remaining amount detection unit 120 selects the second method, that is, the combined system, and detects the toner remaining amount based on the physical attribute measured by the measurement unit 50 and the toner consumption amount detected from the input image data. The detailed flow of the remaining amount detection processing here is as described using FIG. 9.

In step S131, the remaining amount detection unit 120 selects the first method, that is, the pixel count system, and estimates the toner remaining amount based on the toner consumption amount estimated from the input image data. The detailed flow of the remaining amount detection processing here is as described using FIG. 8.

Next, in step S132, the printing control unit 115 causes the operation unit 70 or the display of the external device to display the remaining amount information regarding the toner remaining amount detected by the remaining amount detection unit 120 in step S130 or step S131. Further, the printing control unit 115 updates the status information stored in the cartridge memory M so as to reflect the latest toner remaining amount. The printing control unit 115 updates the “toner remaining amount” in the status information, and can also update the “number of printed sheets” according to the number of sheets consumed in the print job.

In step S132, when the information on the toner remaining amount detected by the remaining amount detection unit 120 is less than a predetermined remaining amount threshold, the printing control unit 115 may cause the display to display, together with the remaining amount information, a warning message prompting the user to replace the cartridge 10. Then, the remaining amount information update processing of FIG. 12 ends.

Note that, although an example of updating the support information in the memory according to the result of the attempt at measurement of the physical attribute in step S126 has been described here, the result of selection of the final detection method including the threshold determination of the toner filling amount in step S128 may be written in the memory. After the result of selection of the final detection method is written once in the memory, the remaining amount detection unit 120 may perform subsequent selection of the detection method based on the written information.

Also in the modification described above, the accuracy of the remaining amount information can be improved by detecting the toner remaining amount by a detection method suitable for the configuration of the remanufactured cartridge. Further, since measurement of the physical attribute is attempted only when the information read from the cartridge memory indicates that it is unknown whether the cartridge supports physical remaining amount detection, the number of attempts of measurement can be suppressed and the processing can be made efficient.

### Other Modifications

As another modification of the first embodiment, selection of the detection method may be performed based on match/mismatch of the “cartridge type” between the original information and the remanufacture processing information stored in the cartridge memory M. In this case, the remaining amount detection unit 120 compares the “cartridge type” stored in the original information area M1 of the cartridge memory M with the “cartridge type” stored in the remanufacture processing information area M2 to determine match/mismatch. If both match, the remaining amount detection unit 120 regards the cartridge 10 after remanufacture as being the same as or substantially equivalent to the specifications of the original cartridge. Then, the remaining amount detection unit 120 detects information on the toner remaining amount by the same method as the remaining amount detection system associated with the “cartridge type” of the original information. For example, if the original cartridge type is a type that supports physical remaining amount detection, the remaining amount detection unit 120 detects information on the toner remaining amount of the cartridge 10 after remanufacture by a combined system of direct detection and indirect detection. If the original cartridge type is a type that does not support physical remaining amount detection, the remaining amount detection unit 120 detects information on the toner remaining amount of the cartridge 10 after remanufacture by indirect detection such as the pixel count system.

On the other hand, if the original cartridge type and the cartridge type of the remanufacture processing information do not match, there is a high possibility that a specification change has occurred due to remanufacture. For this reason, in consideration of a risk of a decrease in reliability of the measurement result of physical remaining amount detection, the remaining amount detection unit 120 detects information on the toner remaining amount by indirect detection such as the pixel count system. This switching based on match/mismatch may be used together with each determination/condition of the above (1) to (4) (for example, physical remaining amount detection support information, measurement attempt result, filling amount threshold). That is, when the “cartridge type” matches, it is also possible to switch from the combined system to the pixel count system by an additional condition while prioritizing method selection according to the original. Conversely, when they do not match, variations are also allowed such as using the combined system when a measurement attempt succeeds or a sufficient toner filling amount can be guaranteed while using the pixel count system as a general rule.

### 7-4. Second Embodiment

In the second embodiment, the remaining amount detection unit 120 determines whether the cartridge 10 mounted in the image forming apparatus 100 has undergone remanufacture processing. Then, when it is determined that the cartridge 10 has undergone remanufacture processing, the remaining amount detection unit 120 detects information on the toner remaining amount according to the first method, that is, the pixel count system. Further, when it is determined that the cartridge 10 has not undergone remanufacture processing (that is, it is new), the remaining amount detection unit 120 detects information on the toner remaining amount according to the second method, that is, the combined system. In this embodiment, the remaining amount detection unit 120 does not have to determine whether the cartridge 10 mounted in the image forming apparatus 100 supports physical remaining amount detection.

As described above, the “number of printable sheets” of the remanufacture processing information shown in FIG. 7A and FIG. 7B is an example of information representing whether or not the cartridge 10 has undergone remanufacture processing. The “cartridge type” of the remanufacture processing information is another example of information representing whether or not the cartridge 10 has undergone remanufacture processing. The remaining amount detection unit 120 can determine whether the cartridge 10 mounted in the image forming apparatus 100 has undergone remanufacture processing based on such remanufacture processing information read from the cartridge memory M.

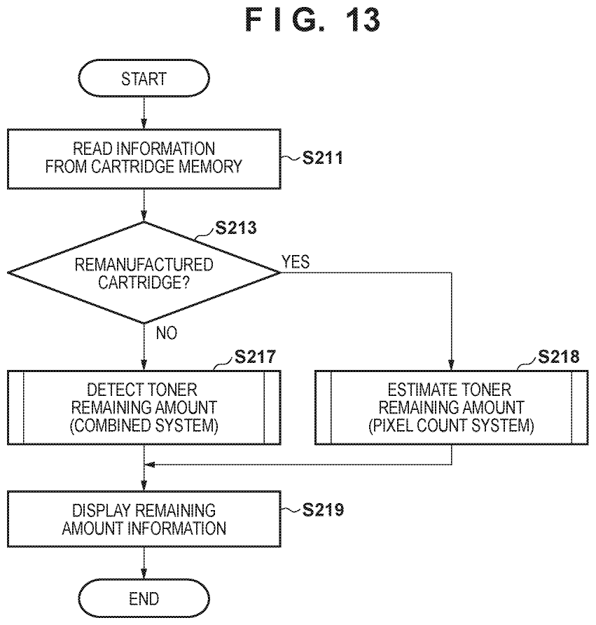

FIG. 13 is a flowchart showing an example of a flow of remaining amount information update processing according to the second embodiment. The remaining amount information update processing of FIG. 13 is performed by the controller 110 when the image forming apparatus 100 executes a print job.

First, in step S211, the printing control unit 115 reads original information, remanufacture processing information, and status information from the cartridge memory M of the cartridge 10 mounted in the image forming apparatus 100. The printing control unit 115 delivers the read information to the remaining amount detection unit 120.

Next, in step S213, the remaining amount detection unit 120 determines whether or not the cartridge 10 has undergone remanufacture processing based on the remanufacture processing information read from the cartridge memory M. For example, the remaining amount detection unit 120 can determine whether or not the cartridge 10 has undergone remanufacture processing by referring to the “number of printable sheets” or the “cartridge type” of the remanufacture processing information. If it is determined that the cartridge 10 has undergone remanufacture processing, the process advances to step S218. On the other hand, if it is determined that the cartridge 10 has not undergone remanufacture processing, the process advances to step S217.

In step S217, the remaining amount detection unit 120 selects the second method, that is, the combined system, and detects the toner remaining amount based on the physical attribute measured by the measurement unit 50 and the toner consumption amount estimated from the input image data. The detailed flow of the remaining amount detection processing here is as described using FIG. 9.

In step S218, the remaining amount detection unit 120 selects the first method, that is, the pixel count system, and estimates the toner remaining amount based on the toner consumption amount estimated from the input image data. The detailed flow of the remaining amount detection processing here is as described using FIG. 8.

Next, in step S219, the printing control unit 115 causes the operation unit 70 or the display of the external device to display the remaining amount information indicating the toner remaining amount detected by the remaining amount detection unit 120 in step S217 or step S218. Further, the printing control unit 115 updates the status information stored in the cartridge memory M so as to reflect the latest toner remaining amount. The printing control unit 115 updates the “toner remaining amount” in the status information, and can also update the “number of printed sheets” according to the number of sheets consumed in the print job.

In step S219, when the information on the toner remaining amount detected by the remaining amount detection unit 120 is less than a predetermined remaining amount threshold, the printing control unit 115 determines that it is the end-of-life of the cartridge 10. Then, the printing control unit 115 may cause the display to display, together with the remaining amount information, a warning message prompting the user to replace the cartridge 10.

Then, the remaining amount information update processing of FIG. 13 ends. When the information on the toner remaining amount is less than the remaining amount threshold, the user who has seen the displayed warning message can remove the used cartridge 10 from the image forming apparatus 100 and mount a new cartridge 10 to the image forming apparatus 100. The used cartridge 10 can be collected by a collector and undergo remanufacture processing by a remanufacturer.

According to the second embodiment described above, when a remanufactured cartridge is mounted in the image forming apparatus, the remaining amount of toner in the remanufactured cartridge is estimated by the pixel count system instead of the combined system that can be used for a new cartridge. Generally, the content of remanufacture processing performed for a used cartridge, and the quality and amount of toner with which the cartridge is refilled vary among remanufacturers. In a remanufactured cartridge, parts that have not been sufficiently cleaned or have deteriorated may be used. Such variation in specifications, configuration, or property of a remanufactured cartridge reduces the accuracy of detection of information on the toner remaining amount by physical remaining amount detection designed on the premise of a new cartridge. Therefore, by detecting information on the toner remaining amount exclusively by the pixel count system when a remanufactured cartridge is mounted in the image forming apparatus, a decrease in accuracy of a detection result of information on the toner remaining amount is avoided, and accuracy of remaining amount information can be improved.

### 8. Other Embodiments

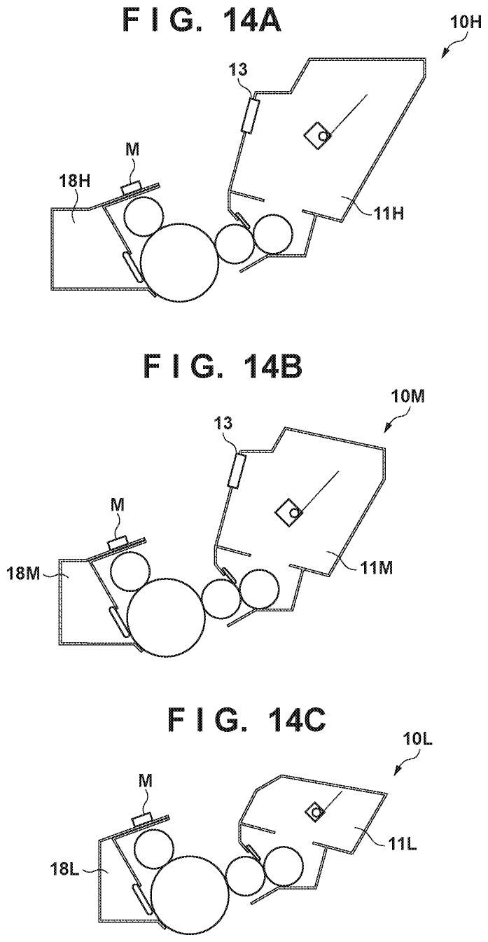

In the present specification, two types of cartridges, namely a large-capacity cartridge and a small-capacity cartridge, have been mainly exemplified, but the technique according to the present disclosure is also applicable to a situation where more types of cartridges may be mounted in the image forming apparatus. For example, FIG. 14A to FIG. 14C show examples of three different cartridges mountable in the same image forming apparatus. The cartridge 10H shown in FIG. 14A is a process cartridge including a large-capacity toner storage part 11H and a large-capacity waste toner container 18H. The cartridge 10M shown in FIG. 14B is a process cartridge including a medium-capacity toner storage part 11M and a medium-capacity waste toner container 18M. The cartridge 10L shown in FIG. 14C is a process cartridge including a small-capacity toner storage part 11L and a small-capacity waste toner container 18L. The cartridge 10H and the cartridge 10M have the light transmissive part 13 and support physical remaining amount detection. On the other hand, the cartridge 10L does not have the light transmissive part 13 and does not support physical remaining amount detection. The cartridge 10H may have two or more (or two or more types) of components for physical remaining amount detection.

According to the present disclosure, detection of the remaining amount of developer in a remanufactured cartridge can be improved. Thereby, it is possible to contribute to the realization of a sustainable society such as a decarbonized/circular economy society.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-050555, filed Mar. 25, 2025, and Japanese Patent Application No. 2026-015579, filed Feb. 2, 2026 which are hereby incorporated by reference herein in their entirety.

What is claimed is:

1. An image forming apparatus to which a cartridge is detachably mountable, the cartridge having a container for containing developer and a memory for storing remanufacture processing information indicating whether the cartridge has undergone a remanufacture, the image forming apparatus being for forming an image based on input image data on a sheet using the developer, the image forming apparatus comprising:
a measuring unit configured to measure a first value when an amount of the developer contained in the container is a first amount, and measure a second value different from the first value when the amount of the developer is a second amount smaller than the first amount;
a direct detection unit configured to detect first information regarding the amount of the developer of the cartridge based on the value measured by the measuring unit;
an estimation unit configured to estimate second information regarding the amount of the developer of the cartridge without using the value measured by the measuring unit;
a determination unit configured to make a determination on an end-of-life of the cartridge based on the first information or the second information; and
a control unit configured to control the measuring unit, the direct detection unit, the estimation unit, and the determination unit, and acquire the remanufacture processing information stored in the memory, wherein
the control unit controls the determination unit to: make the determination on the end-of-life of the cartridge based on the second information and not based on the first information when the remanufacture processing information indicates that remanufacture has been performed, and
make the determination on the end-of-life of the cartridge based on the first information when the remanufacture processing information indicates that remanufacture has not been performed.

2. An image forming apparatus to which a cartridge is detachably mountable, the cartridge having a container for containing developer and a memory for storing remanufacture processing information indicating whether the cartridge has undergone a remanufacture, the image forming apparatus being for forming an image based on input image data on a sheet using the developer, the image forming apparatus comprising:
a measuring unit configured to measure a first value when an amount of the developer contained in the container is a first amount, and measure a second value different from the first value when the amount of the developer is a second amount smaller than the first amount;
a direct detection unit configured to detect first information regarding the amount of the developer of the cartridge based on the value measured by the measuring unit;
an estimation unit configured to estimate second information regarding the amount of the developer of the cartridge without using the value measured by the measuring unit;
a determination unit configured to make a determination on an end-of-life of the cartridge based on the first information or the second information; and
a control unit configured to control the measuring unit, the direct detection unit, the estimation unit, and the determination unit, and acquire the remanufacture processing information stored in the memory, wherein
the memory of the cartridge has, regarding the cartridge, a read-only storage area in which original specifications are written and a read-write area in which specifications after remanufacture are written, and
the control unit controls the determination unit to select information to be used for the determination on the end-of-life from the first information and the second information according to information regarding a capacity of the developer read from the read-write area of the memory of the cartridge mounted in the image forming apparatus, and cause the determination unit to make the determination on the end-of-life of the cartridge based on the selected information.

3. The image forming apparatus according to claim 2, wherein
the memory of the cartridge stores filling amount information representing a filling amount of the developer in a remanufacture of the cartridge, and
the control unit controls the determination unit to:
make the determination on the end-of-life of the cartridge based on the first information acquired by the direct detection unit when the filling amount of the developer represented by the filling amount information read from the memory exceeds a predetermined threshold, and
make the determination on the end-of-life of the cartridge based on the second information estimated by the estimation unit when the filling amount of the developer represented by the filling amount information read from the memory is less than the predetermined threshold.

4. The image forming apparatus according to claim 2, wherein
the control unit causes the measuring unit to attempt measurement of information regarding the amount of the developer in the cartridge, and determines information regarding the amount of the developer contained in the cartridge based on a result of the attempt.

5. The image forming apparatus according to claim 2, wherein
the cartridge has a memory storing support information representing whether the cartridge supports measurement by the measuring unit, and
the control unit determines a system for detecting information regarding the amount of the developer contained in the cartridge based on the support information read from the memory.

6. The image forming apparatus according to claim 1, wherein
the measuring unit measures a value corresponding to a remaining amount of developer by an optical transmission type system, and
the cartridge includes a transmissive part used for measurement of the value corresponding to the remaining amount of developer of the optical transmission type system.

7. The image forming apparatus according to claim 1, wherein
the value measured by the measuring unit includes at least one of a value regarding light shielding by the developer in the cartridge, a value regarding an electrostatic capacity of the developer, and a value regarding a weight of the developer.

8. The image forming apparatus according to claim 1, further comprising an image forming unit configured to:
charge a photosensitive member,
form an electrostatic latent image on a surface of the photosensitive member by exposing the charged photosensitive member according to the input image data, and
develop the electrostatic latent image using the developer to form a developer image on the surface of the photosensitive member, wherein
the control unit is capable of counting a number of pixels exposed based on the input image data, and
the control unit controls the determination unit to:
make a determination on the end-of-life of the cartridge using a value obtained by counting the number of pixels exposed not based on the first information when the remanufacture processing information indicates that the remanufacture has been performed, and
make a determination on the end-of-life of the cartridge using the first information and a value obtained by counting the number of pixels exposed when the remanufacture processing information indicates that the remanufacture has not been performed.

9. The image forming apparatus according to claim 8, wherein
the control unit controls the determination unit to:
make a determination on the end-of-life of the cartridge using a value obtained by counting the number of pixels exposed not based on the first information when the remanufacture processing information indicates that the remanufacture has been performed, and
make a determination on the end-of-life of the cartridge by correcting a value obtained by counting the number of pixels exposed with the first information when the remanufacture processing information indicates that the remanufacture has not been performed.

10. The image forming apparatus according to claim 1,
further comprising a display control unit,
wherein the control unit controls the display control unit to cause a display unit to display information regarding the detected amount of the developer.

11. An image forming apparatus to which a cartridge containing developer is detachably mountable, the image forming apparatus being for forming an image based on input image data on a sheet using developer supplied from the mounted cartridge, the image forming apparatus comprising:
a measuring unit configured to measure information regarding an amount of the developer in the cartridge;
a control unit capable of executing, as a system for detecting information regarding the amount of the developer in the cartridge, a first system that estimates information regarding the amount of the developer from the input image data without using measurement by the measuring unit and a second system that detects information regarding the amount of the developer using at least measurement by the measuring unit;
wherein the cartridge has a memory for storing remanufacture processing information representing whether the cartridge has undergone a remanufacture, and
the control unit determines whether the cartridge has undergone a remanufacture based on the remanufacture processing information read from the memory of the cartridge mounted in the image forming apparatus, and
when it is determined that the cartridge has undergone a remanufacture, the control unit detects the amount of developer in the mounted cartridge according to the first system, regardless of a type of the mounted cartridge.
